(19) United States
(12) Patent Application Publication
(10) Pub. No.: US 2026/0180743 A1
(43) Pub. Date: Jun. 25, 2026

(54) ELECTRONIC DEVICE AND METHOD FOR SCANNING AND SEPARATING AUDIO DATA IN ELECTRONIC DEVICE

(71) Applicant: SAMSUNG ELECTRONICS CO., LTD., Suwon-si (KR)

(72) Inventors: Joonhyun CHOI, Suwon-si (KR); Wonguen CHO, Suwon-si (KR); Jaesik SOHN, Suwon-si (KR); Boyoung KIM, Suwon-si (KR); Hoseol JEON, Suwon-si (KR); Taeyun KIM, Suwon-si (KR)

(73) Assignee: SAMSUNG ELECTRONICS CO., LTD., Suwon-si (KR)

(21) Appl. No.: 19/431,266

(22) Filed: Dec. 23, 2025

Related U.S. Application Data
(63) Continuation of application No. 17/758,504, now Pat. No. 12,526,096.

(30) Foreign Application Priority Data
Dec. 23, 2024 (KR) 10-2024-0194349
Jan. 14, 2025 (KR) 10-2025-0005547
Feb. 26, 2025 (KR) 10-2025-0025261

(51) Int. Cl. H04L 5/00; H04B 7/024; H04W 52/32; H04W 52/36

(52) U.S. Cl. CPC H04L 5/0048; H04B 7/024; H04W 52/325; H04W 52/36

(57) ABSTRACT

An electronic device configured to determine a first scan interval by using a time period corresponding to the audio content so that a scan time for the audio content does not exceed a specified maximum scan time. The electronic device configured to identify audio data of a first plurality of sound sources corresponding to first audio data of a first time period among the audio data corresponding to the audio content. The audio data of the first plurality of sound sources is identified by using a result of the scanning of the audio content while playing the audio data corresponding to the audio content. The electronic device configured to obtain the audio data of the first plurality of sound sources by performing separation of the first audio data of the first time period using a real time factor value.

### CROSS-REFERENCE TO RELATED APPLICATIONS

This application is a continuation of International Application PCT/KR2025/022559, filed on Dec. 23, 2025, which is based on and claims priority to Korean Patent Application No. 10-2024-0194349, filed on Dec. 23, 2024, in the Korean Intellectual Property Office, Korean Patent Application No. 10-2025-0005547, filed on Jan. 14, 2025, in the Korean Intellectual Property Office, and Korean Patent Application No. 10-2025-0025261, filed on Feb. 26, 2025, in the Korean Intellectual Property Office, the disclosures of which are incorporated by reference herein in their entireties.

### 1. FIELD

The disclosure relates to a method for scanning and separating audio data in an electronic device.

### BACKGROUND ART

### 2. Description of Related Art

With the development of electronic information and communication technologies, various functions are being integrated into communication devices or electronic devices. Additionally, electronic devices are being implemented to perform an interworking function for interworking with other electronic devices via communication. For example, a portable electronic device (e.g., mobile terminal, tablet terminal, or wearable electronic device) includes a communication function as well as a content playback function. The portable electronic device may play not only the sound sources stored when manufactured but also various received sound sources. With the recent advancement of content processing technology, electronic devices may provide editing functions for editing content as well as the function for playing content.

The background technology described above is technical information that the inventor possessed for deriving the disclosure or acquired in the process of deriving the disclosure and therefore cannot necessarily be considered as prior art publicly disclosed before the filing of the disclosure.

### SUMMARY

A content editing function may include an audio separation function that separates sound source data of various categories from the audio stream included in the content. Further, the content editing function may include an audio scanning function that provides a section in which a specific type of sound source is present in the audio stream included in the content.

When the electronic device performs audio separation on the audio stream, audio data in a time period unit longer than a time period unit when playing audio data may be needed. Assuming that the electronic device performs audio separation in real time while playing audio content, the time period (e.g., separation time) needed to separate audio data may take longer than the playback time corresponding to the audio data prepared to play in the buffer. If audio data to be played next is not provided (e.g., stored) to the buffer due to failure in completion of separation of the audio data to be played next in a state in which the playback of the audio data prepared in the buffer is completed, as the separation time is prolonged in the electronic device, audio playback may be stopped to cause sound drops until the audio data to be played next is provided to the buffer.

Therefore, it may be necessary to adjust the processing schedule for audio playback and audio separation so that the separation time needed for audio separation does not take longer than the playback time corresponding to the audio data prepared to play in the buffer when performing audio separation in real time while playing audio content. If the separation time is constant for each audio separation, it may be easy to adjust the processing schedule for audio playback and audio separation. But it may not be easy to adjust the processing schedule for audio playback and audio separation because the separation time in performing audio separation may vary in real time according to the performance of the electronic device and the status of the electronic device. Further, when performing audio separation, the electronic device may generate inference data that accumulates the separation (or analysis) results for one audio content and separate the next audio data using inference data. The electronic device may sequentially play the discontinuous first audio content and second audio content while performing audio separation. In this case, after separating the last audio data of the first audio content and upon separating the first audio data of the second audio content, the inference data accumulated from the separation result of the first audio content may be reset, and the separation result of the second audio content may be accumulated and used as new inference data, which may result in inconsistency in the separation results.

Meanwhile, when the electronic device performs audio scanning on the audio stream, it performs decoding on the audio stream and then performs scanning on the decoded audio data. It may take a long time to decode the entire audio stream and, if the size of the decoded audio data is large, the scan time for the decoded audio data may be prolonged. In order to reduce the scan time of audio data, some of the entire audio data sections are sampled and scanned, but it may be inefficient if fixed sampling sections are used regardless of the real-time performance of the electronic device.

According to an embodiment of the disclosure, it is possible to determine a separation time in real time when performing audio separation in real time while playing audio content in an electronic device and adjust the processing schedule for audio playback and audio separation so that the separation time needed for audio separation is not longer than the playback time corresponding to the audio data prepared to play in the buffer according to the real-time separation time.

According to an embodiment of the disclosure, it is possible to complete a scan operation within a limited scan time by determining and using a sampling section according to a limited scan time and real-time performance of the electronic device when the electronic device performs audio scanning on an audio stream.

According to an embodiment of the disclosure, an electronic device including: a display; an audio output module including a speaker; memory storing instructions; and at least one processor. The instructions, when executed by the at least one processor individually or collectively, cause the electronic device to: based on an input for scanning audio content: determine a first scan interval by using a time period corresponding to the audio content so that a scan time for the audio content does not exceed a specified maximum scan time, and scan the audio content by sampling audio data corresponding to the audio content by using the first scan interval. The instructions, when executed by the at least one processor individually or collectively, cause the electronic device to: based on an input for playing the audio content: identify audio data of a first plurality of sound sources corresponding to first audio data of a first time period among the audio data corresponding to the audio content. The audio data of the first plurality of sound sources is identified by using a result of the scanning of the audio content while playing the audio data corresponding to the audio content. The instructions, when executed by the at least one processor individually or collectively, cause the electronic device to: obtain the audio data of the first plurality of sound sources by performing separation of the first audio data of the first time period using a real time factor value, and output the audio data of the first plurality of sound sources through the audio output module.

In an embodiment, the instructions, when executed by the at least one processor individually or collectively, cause the electronic device to: identify a first separation time for performing the separation of the first audio data of the first time period, and when a size of the audio data of the first plurality of sound sources obtained by performing the separation of the first audio data of the first time period is equal to or larger than a data size corresponding to a first audio rendering time associated with the first separation time: transmit the audio data of the first plurality of sound sources to an audio renderer, and output the audio data of the first plurality of sound sources through the audio output module, or when the size of the audio data of the first plurality of sound sources is smaller than the data size corresponding to the first audio rendering time associated with the first separation time, store the audio data of the first plurality of sound sources in a first buffer of the memory. The instructions, when executed by the at least one processor individually or collectively, cause the electronic device to: obtain audio data of a second plurality of sound sources by performing separation on second audio data of a second time period, the second time period following the first time period, and when the audio data of the first plurality of sound sources is stored in the first buffer: merge the audio data of the first plurality of sound sources and the audio data of the second plurality of sound sources, and transmit the merged audio data to the audio renderer to output through the audio output module.

In an embodiment, the instructions, when executed by the at least one processor individually or collectively, cause the electronic device to: obtain the real time factor value by using a value obtained by dividing separation time by the first time period. The separation time is taken when the electronic device has performed separation before the first audio data of the first time period.

In an embodiment, the instructions, when executed by the at least one processor individually or collectively, cause the electronic device to: identify a cumulative average value of a plurality of real time factor values obtained when performing separation for each of a plurality of audio data before the first audio data of the first time period, and identify the first separation time by using the cumulative average value of the plurality of real time factor values and status information of the electronic device.

In an embodiment, the status information of the electronic device includes at least one of an usage amount of the at least one processor and/or the memory, an occupancy rate of the at least one processor and/or the memory, power consumption of a battery of the electronic device, information of an application which is running in a background of the electronic device, or information of network connection status of the electronic device.

In an embodiment, the instructions, when executed by the at least one processor individually or collectively, cause the electronic device to: when the separation of the first audio data of the first time period is not performed, store the first audio data of the first time period in a second buffer of the memory, and when the first audio data is stored in the second buffer when the audio data of the second plurality of sound sources is obtained by performing the separation of the second audio data of the second time period: merge the first audio data and the audio data of the second plurality of sound sources, transmit the merged first audio data and audio data of the second plurality of sound sources to the audio renderer to output the merged first audio data and audio data of the second plurality of sound sources through the audio output module.

In an embodiment, the audio content includes first audio content including the first audio data of the first time period and second content including the second audio data of the second time period. The instructions, when executed by the at least one processor individually or collectively, cause the electronic device to: identify whether the first audio data of the first time period and the second audio data of the second time period are continuous, and when the first audio data of the first time period and the second audio data of the second time period are continuous, update first inference data by accumulating separation result information for the second content to follow separation result information for the first audio content without initializing the first inference data that has accumulated separation result information for the first audio content, or when the first audio data of the first time period and the second audio data of the second time period are not continuous: initialize the first inference data, and obtain second inference data that has accumulated separation result information for the second content.

In an embodiment, the instructions, when executed by the at least one processor individually or collectively, cause the electronic device to: based on the input for scanning the audio content, obtain the time period corresponding to the audio content, first status information of the electronic device, and the specified maximum scan time, determine the first scan interval and a first skip interval by using the time period corresponding to the audio content, the first status information of the electronic device, and the specified maximum scan time so that the scan time for the audio content does not exceed the specified maximum scan time, obtain audio data of a first section among the audio data corresponding to the audio content by decoding the audio content through a decoder, sample at least part of the audio data of the first section by using the first scan interval and the first skip interval, and identify a sound source category of the audio data of the first section by analyzing the at least part of the audio data of the first section.

In an embodiment, he instructions, when executed by the at least one processor individually or collectively, cause the electronic device to: obtain second status information of the electronic device for scanning audio data of a second section following the audio data of the first section among the audio data corresponding to the audio content, obtain an expected decoding time needed for decoding the audio data of the second section, obtain a scan time needed for scanning audio data of a specified time section, identify a longer time among the expected decoding time and the scan time as an expected scan time for the audio data of the specified time section, determine a second scan interval and a second skip interval of the audio data of the second section based on the expected scan time, the second status information of the electronic device, and the specified maximum scan time, sample at least part of the audio data of the second section by using the second scan interval and the second skip interval, and identify a sound source category of the audio data of the second section by analyzing the at least part of the audio data of the second section.

In an embodiment, the instructions, when executed by the at least one processor individually or collectively, cause the electronic device to: when a first sampling type is specified for sampling using the second scan interval and the second skip interval, calculate a starting point of the second section based on the second scan interval, obtain the audio data of the second section among the audio data corresponding to the audio content by decoding from the starting point of the second section by using the decoder, and sample at least part of the audio data of the second section by using the second scan interval and the second skip interval.

In an embodiment, the instructions, when executed by the at least one processor individually or collectively, cause the electronic device to: when a second sampling type is specified for sampling using the second scan interval and the second skip interval, obtain the audio data of the second section among the audio data corresponding to the audio content by using the decoder, and sample at least part of the audio data of the second section corresponding to the second scan interval.

According to an embodiment of the disclosure, a method for scanning and separating audio data in an electronic device, the method including: based on an input for scanning audio content: determining a first scan interval by using a time period corresponding to the audio content so that a scan time for the audio content does not exceed a specified maximum scan time, and scan the audio content by sampling audio data corresponding to the audio content by using the first scan interval; and based on an input for playing the audio content: identifying audio data of a first plurality of sound sources corresponding to first audio data of a first time period among the audio data corresponding to the audio content. The audio data of the first plurality of sound sources is identified by using a result of the scanning of the audio content while playing the audio data corresponding to the audio content. The method including obtaining the audio data of the first plurality of sound sources by performing separation of the first audio data of the first time period using a real time factor value, and outputting the audio data of the first plurality of sound sources through an audio output module including a speaker.

In an embodiment, the method further includes identifying a first separation time for performing the separation of the first audio data of the first time period, and when a size of audio data of the first plurality of sound sources obtained by performing the separation of the first audio data of the first time period is equal to or larger than a data size corresponding to a first audio rendering time associated with the first separation time: transmitting the audio data of the first plurality of sound sources to an audio renderer, and outputting the audio data of the first plurality of sound sources through the audio output module; or when the size of the audio data of the first plurality of sound sources is smaller than the data size corresponding to the first audio rendering time associated with the first separation time, storing the audio data of the first plurality of sound sources in a first buffer of memory of the electronic device. The method further includes: obtaining audio data of a second plurality of sound sources by performing separation on second audio data of a second time period, the second time period following the first time period; and when the audio data of the first plurality of sound sources is stored in the first buffer: merging the audio data of the first plurality of sound sources and the audio data of the second plurality of sound sources, and transmitting the merged audio data to the audio renderer to output through the audio output module of the electronic device.

In an embodiment, the method further includes obtaining the real time factor value by using a value obtained by dividing separation time by the first time period. The separation time is taken when the electronic device has performed separation before the first audio data of the first time period.

In an embodiment, the method further includes identifying a cumulative average value of a plurality of real time factor values obtained when performing separation for each of a plurality of audio data before the first audio data of the first time period; and identifying the first separation time by using the cumulative average value of the plurality of real time factor values and status information of the electronic device.

In an embodiment, the status information of the electronic device includes at least one of an usage amount of at least one processor and/or memory of the electronic device, an occupancy rate of the at least one processor and/or the memory, power consumption of a battery of the electronic device, information of an application which is running in a background of the electronic device, or information of network connection status of the electronic device.

In an embodiment, the method further includes when the separation of the first audio data of the first time period is not performed, storing the first audio data of the first time period in a second buffer of memory of the electronic device; and when the first audio data is stored in the second buffer when the audio data of the second plurality of sound sources is obtained by performing the separation of the second audio data of the second time period: merging the first audio data and the audio data of the second plurality of sound sources, and transmitting the merged first audio data and audio data of the second plurality of sound sources to the audio renderer to output the merged first audio data and audio data of the second plurality of sound sources through the audio output module.

In an embodiment, the method further includes based on the input for scanning the audio content, obtaining the time period corresponding to the audio content, first status information of the electronic device, and the specified maximum scan time; determining the first scan interval and a first skip interval by using the time period corresponding to the audio content, the first status information of the electronic device, and the specified maximum scan time so that the scan time for the audio content does not exceed the specified maximum scan time; obtaining audio data of a first section among the audio data corresponding to the audio content by decoding the audio content through a decoder of the electronic device; sampling at least part of the audio data of the first section by using the first scan interval and the first skip interval; and identifying a sound source category of the audio data of the first section by analyzing the at least part of the audio data of the first section.

In an embodiment, the method further includes obtaining second status information of the electronic device for scanning audio data of a second section following the audio data of the first section among the audio data corresponding to the audio content; obtaining an expected decoding time needed for decoding the audio data of the second section; obtaining a scan time needed for scanning audio data of a specified time section; identifying a longer time among the expected decoding time and the scan time as an expected scan time for the audio data of the specified time section; determining a second scan interval and a second skip interval of the audio data of the second section based on the expected scan time, the second status information of the electronic device, and the specified maximum scan time; sampling at least part of the audio data of the second section by using the second scan interval and the second skip interval; and identifying a sound source category of the audio data of the second section by analyzing the at least part of the audio data of the second section.

According to an embodiment of the disclosure, a non-transitory storage medium storing instructions. The instructions are configured to, when executed by an electronic device, enable the electronic device to perform at least one operation. The at least one operation including: based on an input for scanning audio content: determining a first scan interval by using a time period corresponding to the audio content so that a scan time for the audio content does not exceed a specified maximum scan time, and scan the audio content by sampling audio data corresponding to the audio content by using the first scan interval; and based on an input for playing the audio content: identifying audio data of first plurality of sound sources corresponding to first audio data of a first time period among the audio data corresponding to the audio content. The audio data of the first plurality of sound sources is identified by using a result of the scanning of the audio content while playing the audio data corresponding to the audio content. The at least one operation including: obtaining the audio data of the first plurality of sound sources by performing separation of the first audio data of the first time period using a real time factor value, and outputting the audio data of the first plurality of sound sources through an audio output module including a speaker . . .

### BRIEF DESCRIPTION OF THE DRAWINGS

FIG. 1 is a block diagram illustrating an electronic device in a network environment according to an embodiment;

FIG. 2 is a block diagram illustrating a configuration of an electronic device according to an embodiment;

FIG. 3 is a block diagram illustrating an audio separator according to an embodiment;

FIG. 4 is a view illustrating separation processing cases of content including a plurality of audio contents in an electronic device according to an embodiment;

FIG. 5 is a flowchart illustrating an audio data separation operation when playing content according to an embodiment;

FIG. 6A is a flowchart illustrating an audio data separation operation according to whether audio data is audio data needed to be separated when content is played according to an embodiment;

FIG. 6B is a flowchart illustrating operations continuing from 6A according to an embodiment;

FIG. 6C is a flowchart illustrating operations continuing from 6b according to an embodiment;

FIG. 7 is a block diagram illustrating an audio scanner according to an embodiment;

FIG. 8 is a view illustrating a decoding time and a scan time for audio data of a section according to an embodiment;

FIG. 9 is a view illustrating an example of setting an analysis period based on a skip interval and a scan interval according to an embodiment;

FIG. 10 is a view illustrating a designated data format for storing scan result information according to an embodiment;

FIG. 11 is a view illustrating sampling processing cases when scanning content according to an embodiment;

FIG. 12 is a flowchart illustrating an audio data scan operation according to an embodiment;

FIG. 13A is a flowchart illustrating an audio data scan operation according to the presence of a previously obtained scan interval and skip interval according to an embodiment;

FIG. 13B is a flowchart illustrating operations continuing from 13A according to an embodiment;

FIG. 13C is a flowchart illustrating operations continuing from 13B according to an embodiment;

FIG. 14 is a flowchart illustrating a scan operation on audio content including scan result information according to an embodiment;

FIG. 15 is a view illustrating an example of a screen for audio scanning according to an embodiment;

FIG. 16 is a view illustrating an example of a screen displaying an audio scan result according to an embodiment;

FIG. 17 is a view illustrating an example of a screen for content editing according to an embodiment; and

In connection with the description of the drawings, the same or similar reference numerals may be used to denote the same or similar elements.

### DETAILED DESCRIPTION

The terms as used herein are provided merely to describe some embodiments thereof, but not to limit the scope of other embodiments of the disclosure. It is to be understood that the singular forms “a,” “an,” and “the” include plural references unless the context clearly dictates otherwise. All terms including technical and scientific terms used herein have the same meaning as commonly understood by one of ordinary skill in the art to which the embodiments of the disclosure belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In some cases, the terms defined herein may be interpreted to exclude embodiments of the disclosure.

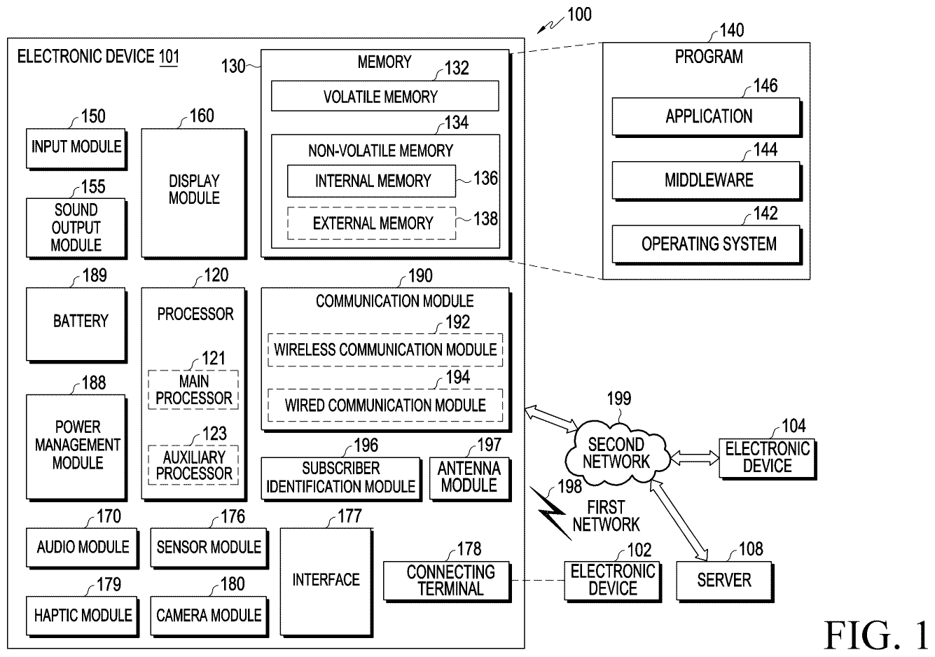

FIG. 1 is a block diagram illustrating an electronic device 101 in a network environment 100 according to various embodiments.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, an audio output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The audio output module 155 may output sound signals to the outside of the electronic device 101. The audio output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the audio output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

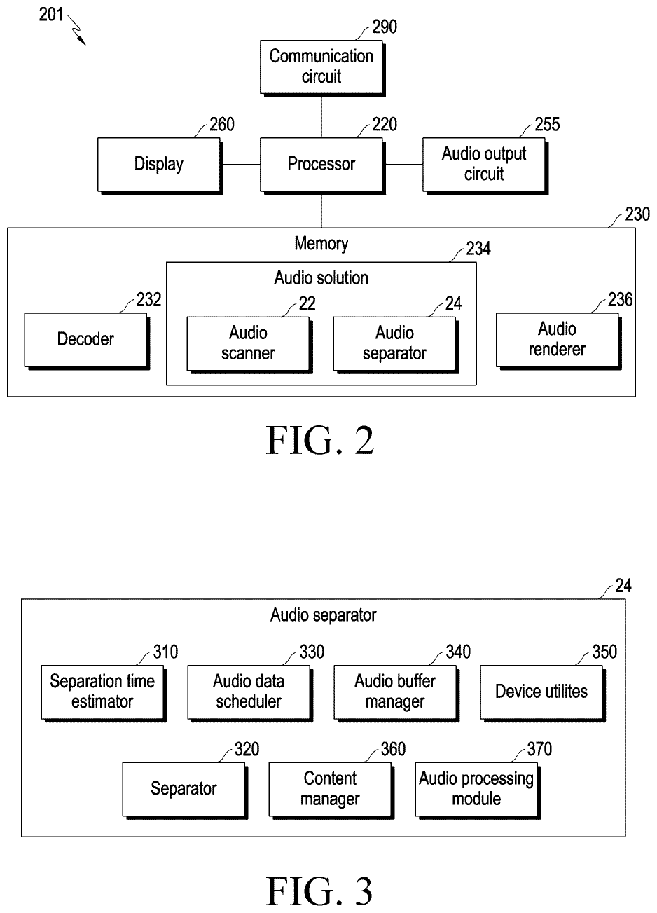

FIG. 2 is a block diagram illustrating an electronic device according to an embodiment.

An electronic device 201 (e.g., the electronic device 101 of FIG. 1) according to an embodiment may include at least one processor (hereinafter, also referred to as a processor) 220, memory 230, a display 260, and/or an audio output module 255. The electronic device 201, according to an embodiment, is not limited thereto, and may be configured to further include various components or to exclude some of the components. According to an embodiment, the electronic device 201 may include the whole or part of the electronic device 101 of FIG. 1.

The processor 220 (e.g., the processor 120 of FIG. 1) according to an embodiment may include a central processing unit (CPU), an application processor (AP), and an audio processor. The processor 220 may include a hardware structure (e.g., an AI chip) specialized for processing an artificial intelligence (AI) model. According to an embodiment, the processor 220 may control an overall control operation of the electronic device 201. The processor 220 according to an embodiment may individually or collectively execute instructions stored in the memory 230 to cause the electronic device 201 to perform an audio data separation operation (or method) when playing the content of the disclosure. The processor 220 according to an embodiment may individually or collectively execute instructions stored in the memory 230 to cause the electronic device 201 to perform an audio data scan operation (or method) of the disclosure. The processor 220 according to an embodiment may independently perform an audio data separation operation and an audio data scan operation during content playback. The processor 220 according to an embodiment may perform the audio data separation operation after performing the audio data scan operation.

When performing the audio data separation operation after performing the audio data scan operation, the processor 220 according to an embodiment may determine a first scan interval (or a first scan interval and a first skip interval) for preventing a scan time for audio content from exceeding a designated maximum scan time using a time period corresponding to the audio content and a designated maximum scan time based on an input for scanning the audio content. The processor 220 according to an embodiment may scan the audio content by sampling audio data corresponding to the audio content using the first scan interval (or the first scan interval and the first skip interval). The processor 220 according to an embodiment may identify at least one sound source audio data included in each time section for each time section of the audio content as a result of scanning the audio content. The processor 220 according to an embodiment may identify a first plurality of sound source audio data corresponding to the first audio data of the first time period among audio data using the scan result for the audio data while playing the audio data of the audio content based on the input for playing the audio content. The processor 220 according to an embodiment may obtain a first plurality of sound source audio data by performing separation on the first audio data of the first time period using a real time factor value, and output the first plurality of sound source audio data through the audio output module 255.

The processor 220 according to an embodiment of the disclosure may initiate an operation for separating audio data while playing content based on an input for playing (or separating or editing) content.

Audio separation (or sound source separation) according to an embodiment may refer to separating at least one sound source audio data corresponding to a sound source (e.g., vocal, musical instrument, background sound, noise, and/or other sound sources) of at least one designated category (or classification criterion) from audio data (e.g., pulse-code modulation (PCM) data) of a predetermined period (or a predetermined duration) and obtaining at least one separated sound source audio data. For example, the audio data may include a plurality of sound sources in a plurality of categories. The plurality of sound sources may include a first sound source (vocal) and a second sound source (instrument). The processor 220 may separate the first sound source audio data corresponding to the vocal and the second sound source audio data corresponding to the instrument from the audio data. The processor 220 may obtain the separated first sound source audio data and second sound source audio data. The processor 220 according to an embodiment may use at least one sound source audio data obtained through audio separation when playing the content or editing the content. For example, the processor 220 may separate sound source audio data from audio content when playing (or editing) audio content, adjust the volume (e.g., volume up or down) of the sound source audio data, or remove the sound source audio data from the audio content.

The processor 220 according to an embodiment may obtain audio data by decoding audio content (e.g., the audio stream) through the decoder 232 based on an input for playing (or editing) content. For example, the audio stream may be content in the form for continuously transmitting digital audio data over time. Content according to an embodiment may include audio content or may include audio content and video content. The audio content according to an embodiment may include first audio content and second audio content. The first audio content and the second audio content according to an embodiment may be continuous and different audio data. The processor 220 according to an embodiment may display a screen for playing (or editing) content on the display 260 based on the execution of a content playback application (or content editing application) (or program). The processor 220 according to an embodiment may identify an input for playing content based on a user input to a button (or icon) for requesting playback on the screen for playing (or editing) content.

The processor 220 according to an embodiment may obtain audio data (e.g., PCM data) by decoding the audio content through the decoder 232 based on identifying an input for playing the content. PCM data according to an embodiment is a format representing digital audio data, and may be data obtained by sampling the amplitude of sound waves at specific time intervals to convert analog audio signals (sounds) into digital signals and representing them as discrete numbers. For example, PCM data size (e.g., bytes) during a predetermined duration (e.g., 1 second) may be calculated by multiplying the sampling rate, sample size, and channel count. The processor 220 according to an embodiment may decode audio content through the decoder 232 to continuously output (or obtain) PCM data having a designated duration (e.g., 0.5 seconds). The processor 220 according to an embodiment may perform synchronous decoding or asynchronous decoding through the decoder 232. When a seek time is designated by the user while the continuously playback of audio content is performed through the decoder 232, the processor 220 according to an embodiment may output PCM data corresponding to the designated seek time. According to an embodiment, the output time of PCM data through the decoder 232 may vary according to the content configuration and, when a seek is requested, the time taken to output PCM data may be increased by flushing the PCM data obtained before the seek request. The processor 220 according to an embodiment may perform audio separation and/or audio scan considering the time taken to output (or obtain) PCM data through the decoder 232.

The processor 220 according to an embodiment may identify whether the audio data (PCM data) continuously output through the decoder 232 is audio data needed to be separated.

The processor 220 according to an embodiment may store audio data not needed to be separated in a buffer (e.g., a second buffer or an intermediate buffer) designated to store audio data not needed to be separated. The audio data stored in the second buffer may be transmitted to the audio renderer 236 at an audio rendering time corresponding to the stored audio data.

The processor 220 according to an embodiment may store audio data needed to be separated in a designated buffer (e.g., single buffer or double buffer) so that the audio data may be transmitted to the audio separator 24. The processor 220 according to an embodiment may utilize a single buffer (single buffering) or a plurality of buffers (double buffering) depending on the status information about the electronic device 201 and/or the presence of a delay in the separation operation through the audio separator 24. When the status information about the electronic device 201 indicates that a plurality of buffers are available, and the separation operation is delayed, the processor 220 according to an embodiment may parallelize the audio data to be separated using the plurality of buffers. The processor 220 according to an embodiment may sequentially process the audio data to be separated using one buffer when the status information about the electronic device 201 indicates that the plurality of buffers are not available or the separation operation is not delayed.

The processor 220 according to an embodiment may accumulate separation result information for the audio content while performing the separation operation on the audio data needed to be separated among the audio data of the audio content and use the inference data accumulated so far when performing the separation operation on the next audio data. When the content includes the first audio content and the second audio content, and the processor 220 according to an embodiment separates the first audio content and then separates the second audio content, if the first audio content and the second audio content do not have continuity, the quality of the separation result may be poor when the first inference data accumulated for the first audio content is applied to the second content.

When the audio content includes the first audio content and the second audio content, and the first audio data of the first time period among the audio data to be separated is included in the first audio content, and the second audio data of the second time period among the audio data to be separated is included in the second content, the processor 220 according to an embodiment may identify whether the first audio data of the first time period and the second audio data of the second time period are continuous. When the first audio data of the first time period and the second audio data of the second time period have continuity, the processor 220 according to an embodiment may, rather initializing the first inference data accumulating the separation result information for the first audio content, further accumulate the separation result information for the second audio content following the separation result information for the first audio content to update the first inference data. When the first audio data of the first time period and the second audio data of the second time period do not have continuity, the processor 220 according to an embodiment may reset the first inference data accumulating the separation result information for the first audio content, and obtain and use the second inference data accumulating the separation result information for the second audio content.

While playing audio data, the processor 220 according to an embodiment may identify a first separation time needed to perform separation on the first audio data (e.g., input PCM data of the audio separator 24) of the first time period among the audio data to be separated through the audio separator 24. For example, the processor 220 may obtain the PCM data of the first time period (e.g., 2 seconds) obtained by collecting a designated amount (e.g., a designated PCM data amount for performing separation) of PCM data of a designated time (e.g., 0.5 seconds) output (or obtained) through the decoder 232 as the first audio data of the first time period which is the input PCM data for performing separation through the audio separator 24.

The processor 220 according to an embodiment may obtain (or calculate) a first time period (e.g., a PCM input duration) corresponding to the input PCM data based on Equation 1 below.

$$PCMinputduration = PCMsize / ( channel * speed * samplerate * bitdepth ) \qquad [ Equation 1 ]$$

In Equation 1, the PCM size may be the data size of input PCM data input to the audio separator 24 to perform separation. The channel may be the channel of the input PCM data. Speed may be the speed of the input PCM data. The sample rate may be the sample rate of the input PCM data. The bit depth may be the bit depth of the input PCM data.

The processor 220 according to an embodiment may identify a first separation time to be needed to perform separation on the input PCM data of the first time period based on Equation 2 below.

$$Realtimefactor = separationtime / PCMinputduration \qquad [ Equation 2 ]$$

According to Equation 2, the separation time may be the actual separation time needed when the electronic device 201 performs separation before the first audio data of the first time period. The processor 220 according to an embodiment may obtain a real time factor value using a value obtained by dividing the separation time by the first time period. The processor 220 according to an embodiment may identify the first separation time needed to perform separation on the first audio data of the first time period using the real time factor value. The processor 220 according to an embodiment may obtain a cumulative average of previous real time factor values obtained when separating each of the plurality of audio data before the first audio data of the first time period and identify the first separation time for the first audio data of the first time period using the cumulative average of the real time factor values. The processor 220 according to an embodiment may obtain a cumulative average of previous real time factor values obtained when separating each of the plurality of audio data before the first audio data of the first time period, and identify the first separation time for the first audio data of the first time period using the cumulative average of the real time factor values and the status information about the electronic device. The status information about the electronic device 201 according to an embodiment may include the usage amount and/or occupancy rate of at least one processor 220 (e.g., CPU, AP, and/or audio processor) and/or memory 230, power consumption of the battery (e.g., 189 of FIG. 1) of the electronic device 201, an application running in the background of the electronic device 201, and/or network connection status information about the electronic device 201.

The processor 220 according to an embodiment may obtain a first plurality of sound source audio data by performing separation on the first audio data of the first time period through the audio separator 24. According to an embodiment, the processor 220 may transmit the PCM data of the first time (e.g., minimum analysis (or separation) duration)) period (e.g., 2 seconds) obtained by collecting a designated amount (e.g., a designated PCM data amount for performing separation) of PCM data of a designated time (e.g., 0.5 seconds) obtained through the decoder 232 to the audio separator 24 and perform separation on the first audio data of the first time period through the audio separator 24 to obtain a first plurality of sound source audio data. The processor 220 according to an embodiment may obtain a first plurality of sound source audio data by performing separation of individually extracting a plurality of sound sources (e.g., vocal, musical instrument, background sound, noise, and/or other sources) from the first audio data of the first time period through the audio separator 24. For example, separation may be sound source separation. The processor 220 according to an embodiment may perform sound source separation using a designated number of pieces of classification information through the audio separator 24, and the designated number may not be limited to a specific number.

The processor 220 according to an embodiment may determine whether the data size of the first plurality of sound source audio data is equal to or larger than the size of audio data corresponding to the first audio rendering time (or the first playback time) associated with the first separation time. According to an embodiment, the first audio rendering time may be the time needed to perform audio rendering (or play) audio data prepared for audio rendering in a buffer (e.g., a first buffer, an output buffer, or a buffer that stores audio data to be input to the audio renderer 236). The processor 220 according to an embodiment may determine whether the data size of the first plurality of sound source audio data is equal to or larger than the data size corresponding to the first audio rendering time associated with the first separation time. For example, if the data size of the first plurality of sound source audio data is equal to or larger than the size of the audio data corresponding to the first audio rendering time associated with the first separation time, the amount of the first plurality of sound source audio data audio-rendered is not insufficient when separating the second time period following the first time period, so that no audio drop may occur between the audio output for the first plurality of sound source audio data and the audio output for the second plurality of sound source audio data. For example, if the data size of the first plurality of sound source audio data is not equal to or larger than (or is smaller than) the size of the audio data corresponding to the first audio rendering time associated with the first separation time, the amount of the first plurality of sound source audio data audio-rendered may become insufficient when the second audio data is being separated, resulting in an audio drop between the audio output for the first plurality of sound source audio data and the audio output for the second plurality of sound source audio data.

The processor 220 according to an embodiment may perform audio rendering on the first plurality of sound source audio data through the audio renderer 236 and output the same through the audio output module 255 if the data size of the first plurality of sound source audio data is equal to or larger than the data size corresponding to the first audio rendering time associated with the first separation time. The processor 220 according to an embodiment may adjust the volume of each of the first plurality of sound source audio data. The processor 220 according to an embodiment may adjust the volume of each of the first plurality of sound source audio data to a volume level input by the user or a volume level automatically designated. For example, when the first plurality of sound source audio data includes voice sound source audio data and instrument sound source audio data, and the volume level is designated so that the volume of the voice sound source audio data is 56% by a user input or automatically, the processor 220 may adjust the volume level of the voice sound source audio data, among the first plurality of sound source audio data, to 56% and the volume level of the instrument sound source audio data to 100%. For example, when the first plurality of sound source audio data includes voice sound source audio data and noise sound source audio data, and it is designated that noise is removed by a user input or automatically, the processor 220 may adjust the volume level of the voice sound source audio data among the first plurality of sound source audio data to 100% and the volume level of the noise sound source audio data to 0%. The processor 220 according to an embodiment may mix the first plurality of sound source audio data adjusted in volume and transmit the mixed first plurality of sound source audio data to the audio renderer 236. The processor 220 according to an embodiment may audio-render the mixed first plurality of sound source audio data through the audio renderer 236 and output the same through the audio output module 255.

If the data size of the first plurality of sound source audio data is smaller than the data size corresponding to the first audio rendering time associated with the first separation time, the processor 220 according to an embodiment may delay audio rendering by storing the first plurality of sound source audio data in the first buffer (e.g., an output buffer or a buffer that stores audio data to be input to the audio renderer 236) without transmitting the first plurality of sound source audio data to the audio renderer 236. The processor 220 according to an embodiment may store a first plurality of sound source audio data in the first buffer, and then obtain a second plurality of sound source audio data by performing separation on the second audio data of the second time period after the first time period. The separation of the second audio data may be similar to the separation operation of the first audio data. When the second plurality of sound source audio data is obtained and the first plurality of sound source audio data is present in the first buffer, the processor 220 according to an embodiment may merge the first plurality of sound source audio data with the second plurality of sound source audio data. The processor 220 according to an embodiment may transmit the merged first plurality of sound source audio data and second plurality of sound source audio data to the audio renderer 236. The processor 220 according to an embodiment may adjust the volume of each of the first plurality of sound source audio data and the second plurality of sound source audio data, mix the first plurality of sound source audio data and the second plurality of sound source audio data having the adjusted volume, and transmit the mixed first plurality of sound source audio data and second plurality of sound source audio data to the audio renderer 236 to output the same through the audio output module 255. According to an embodiment, when the data size of the first plurality of sound source audio data is smaller than the size of the audio data corresponding to the first audio rendering time associated with the first separation time, the processor 220 stores the first plurality of sound source audio data in the first buffer and, when the next second plurality of sound source audio data is obtained, merge the first plurality of sound source audio data and the second plurality of sound source audio data and perform audio rendering. Thus, it is possible to prevent an audio drop from occurring between the audio output of the first plurality of sound source audio data and the audio output of the second plurality of sound source audio data due to insufficiency of the amount of the first plurality of sound source audio data audio-rendered when separation is performed on the second plurality of sound source audio data.

The processor 220 according to an embodiment may repeatedly perform decoding, separation, and audio rendering as described above until the last audio data of the last time period of the audio content is identified, and then may terminate the process if an end (e.g., end of stream (EOS)) of the audio content (e.g., audio stream) is identified.

The processor 220 according to an embodiment of the disclosure may initiate an operation of scanning the audio content based on an input for scanning the audio content.

An audio scan (or scan operation) according to an embodiment may mean obtaining information about a section including a sound source (e.g., vocal, musical instrument, background sound, noise, and/or other sound sources) of a specific category among sections of the audio content (e.g., audio stream) of the content (e.g., video or audio file) desired by the user. The video and audio file according to an embodiment may have one or more audio tracks. The audio track according to an embodiment may include audio content. The processor 220 according to an embodiment may decompress the audio content through the decoder 232 to obtain audio content (e.g., PCM data), and scan the audio content through the audio scanner 22 to obtain information about a section including a sound source of a specific category among sections of the audio content as a result of the scan. The processor 220 according to an embodiment may display the information about the section including the sound source of the specific category among the sections of the audio content when playing (or editing) audio content on the display 260. Accordingly, the user may know which category of sound source is included in which section of the audio content.

When the processor 220 according to an embodiment performs decoding an audio scan for audio content, a different decoding time may be needed according to the length of the audio content and/or real time status information (or performance) of the electronic device 201. The status information about the electronic device 201 according to an embodiment may include the usage amount and/or occupancy rate of at least one processor 220 (e.g., CPU, AP, and/or audio processor) and/or memory 230, power consumption of the battery (e.g., 189 of FIG. 1) of the electronic device 201, an application running in the background of the electronic device 201, and/or network connection status information about the electronic device 201. For example, a short length of audio content may take less time to decode, but a long length of audio content may take a long time to decode. For example, if the real time status information about electronic device 201 is status information corresponding to more than a designated performance, it may take less time to decode, but if the real time status information about electronic device 201 is status information corresponding to less than the designated performance, it may take a long time to decode. The processor 220 according to an embodiment may perform an analysis for identifying whether the sound source of the specific category is included for each designated section in the decoded audio data, and if the analysis section is short, it takes less time and if the analysis section is long, it may take a long time.

The processor 220 according to an embodiment may identify a designated maximum scan time through the audio scanner 22 when scanning audio content and control the scan time of the audio content (e.g., the actual scan time needed until the scan of the audio content is started and completed) not to exceed the designated maximum scan time. The processor 220 according to an embodiment may determine the scan interval and the skip interval in which the scan time for audio content does not exceed the designated maximum scan time using the time period corresponding to the audio content, status information about the electronic device 201, and the designated maximum scan time through the audio scanner 22. The processor 220 according to an embodiment may sample audio data of at least some sections of the audio data using the scan interval and the skip interval through the audio scanner 22, and analyze the audio data of at least some sections to identify the sound source category to which the audio data belongs, so that the audio content is scanned within the limited maximum scan time.

The processor 220 according to an embodiment may load the audio content based on an input for scanning the audio content.

The processor 220 according to an embodiment may identify whether there is previously obtained scan interval and skip interval information corresponding to the loaded audio content. When an initial scan is performed on the loaded audio content, previously obtained scan interval and skip interval information may not are present (e.g., not stored yet). For example, if a scan has been performed on the audio data of at least some sections of the loaded audio content, the previously obtained scan interval and skip interval may be present (e.g., stored).

The processor 220 according to an embodiment may determine a scan interval (e.g., a first scan interval) and a skip interval (e.g., a first scan interval) for audio data of a first section (e.g., an initial scan request interval) among the audio data included in the audio content when the previously obtained scan interval and the skip interval are not present corresponding to the audio content.

The processor 220 according to an embodiment may obtain a time period (content duration) corresponding to the audio content, status information (e.g., first status information) about the electronic device, and a designated maximum scan time when the previously obtained scan interval and skip interval are not present corresponding to the audio content to be scanned. For example, the first status information about the electronic device 101 according to an embodiment may include the usage amount and/or occupancy rate of at least one processor 220 (e.g., CPU, AP, and/or audio processor) and/or memory 230, power consumption of the battery (e.g., 189 of FIG. 1) of the electronic device 201, an application running in the background of the electronic device 201, and/or network connection status information about the electronic device 201, corresponding to a first time (e.g., the first section scan start time of the audio content). For example, the designated maximum scan time may be the scan limit time predefined for an application including the audio scanner 22 or the audio scanner 22 of the electronic device 201. The processor 220 according to an embodiment may obtain a first estimated scan time for the audio content using the time period corresponding to the audio content, first status information about the electronic device, and the designated maximum scan time, and determine (or calculate or identify) the first scan interval and the first skip interval for preventing the first estimated scan time from exceeding the designated maximum scan time.

The processor 220 according to an embodiment may obtain an estimated scan time (e.g., a first estimated scan time) needed to scan audio content by using the value obtained by multiplying the estimated decoding time (e.g., a first estimated decoding time), which is estimated to be needed for decoding the audio content, by the time needed to scan audio data of a block and the number of blocks included in the time period of the audio content.

The processor 220 according to an embodiment may obtain the estimated decoding time (e.g., the first estimated decoding time) using Equation 3 below.

$$Estimated decoding time = average decoding time * content duration \qquad [ Equation 3 ]$$

Referring to Equation 3, average decoding time may be an average decoding time taken to decode audio data in one time unit included in audio content through the decoder 232. Content duration may be the time period of audio content.

The processor 220 according to an embodiment may obtain the estimated scan time (e.g., the first estimated scan time) using Equation 4 below.

$$Estimated scan time = Max ( block scan time * content duration / block , Estimated decoding time ) \qquad [ Equation 4 ]$$

Referring to Equation 4, the estimated scan time may be the greater value between the estimated decoding time (e.g., the first estimated decoding time) and the value obtained by multiplying the time needed to scan audio data of a block by the number of blocks included in the content duration of audio content (content duration/block).

The processor 220 according to an embodiment may decode the audio data by the decoder 232 based on the determination of the first scan interval and the first skip interval, and store the first decoding time needed to decode the audio data of the first section among the audio data.

The processor 220 according to an embodiment may sample audio data of first at least a partial section of the audio data of the first section among the audio data decoded by the decoder 232 using the first scan interval and the first skip interval, and analyze the sampled audio data of the first at least partial section to identify the sound source category to which the audio data of the first section belongs. The processor 220 according to an embodiment may sample the audio data of the first at least partial section of the audio data of the first section, analyze the sampled audio data of the first at least partial section, and store a first scan time taken to identify the sound source category to which the audio data of the first section belongs.

When there is a previously obtained scan interval (e.g., the first scan interval) and a skip interval (e.g., the first scan interval) corresponding to the audio content, the processor 220 according to an embodiment may determine (or update) a scan interval (e.g., the second scan interval) and a skip interval (e.g., the second skip interval) for audio data of a second section (e.g., a section after the first section) among the audio data included in the audio content.

The processor 220 according to an embodiment may obtain the first estimated decoding time, the first estimated scan time, the designated maximum scan time, the audio content time period (e.g., the time period of unscanned audio content among the audio content), and status information (e.g., second status information) about the electronic device to determine the second scan interval and the second skip interval. For example, the second status information about the electronic device 101 according to an embodiment may include the usage amount and/or occupancy rate of at least one processor 220 (e.g., CPU, AP, and/or audio processor) and/or memory 230, power consumption of the battery (e.g., 189 of FIG. 2) of the electronic device 201, an application running in the background of the electronic device 201, and/or network connection status information about the electronic device 201, corresponding to a second time (e.g., the second section scan start time of the audio content).

The processor 220 according to an embodiment may determine (or calculate or identify) a second scan interval and a second skip interval for preventing the second estimated scan time for the audio data of the second section from exceeding the designated maximum scan time using the first estimated decoding time, the first estimated scan time, the designated maximum scan time, and the time period of unscanned audio content among the audio content, and status information (e.g., second status information) about the electronic device. The processor 220 according to an embodiment may identify a start time to which the second scan interval and the second skip interval are to be applied using the second skip interval.

The processor 220 according to an embodiment may sample the audio data of second at least a partial section of the audio data of the second section among the audio data decoded through the decoder 232 based on the determination of the second scan interval and the second skip interval. The processor 220 according to an embodiment may identify a sampling type designated for sampling using the second scan interval and the second skip interval. For example, the designated sampling type may include a first sampling type and/or a second sampling type. For example, the first sampling type may include a seek method (or a mode or operation). The second sampling type may include a drop method (or a mode or operation). When the first sampling type is designated, the processor 220 according to an embodiment may calculate the start time of the second section of the audio content based on the second scan interval, perform decoding from the start time of the second section of the audio content using the decoder 232 to obtain the audio data of the second section, and sample the audio data of the second at least partial section using the second scan interval and the second skip interval among the audio data of the second section. When the second sampling type is designated, the processor 220 according to an embodiment may obtain the audio data of the second section of the audio content using the decoder 232, drop the audio data of the section corresponding to the second skip interval among the audio data of the second section, and sample the audio data of the second at least partial section from the audio data of the second at least partial section corresponding to the second scan interval.

The processor 220 according to an embodiment may analyze the sampled audio data of the second at least partial section to identify the sound source category to which the audio data of the second section belongs.

The processor 220 according to an embodiment may repeatedly perform a scan (or sound source analysis) until the decoded audio data of the last section of the audio content and then end the audio scan operation if an end (e.g., end of stream (EOS)) of the audio content (e.g., audio stream) is identified. The processor 220 according to an embodiment may store audio scan result information in the memory 230 based on the end of the audio scan operation.

The processor 220 according to an embodiment may identify whether audio content scan result information is present in the memory 230 based on an input for requesting scan of the audio content. When the audio content scan result information is not present, the processor 220 according to an embodiment may perform a scan operation on the audio content.

When the audio content scan result information is present, the processor 220 according to an embodiment may identify whether the version of the stored audio content scan result information is a compatible version in the electronic device 201 (e.g., a version available in the electronic device 201).

The processor 220 according to an embodiment may perform a scan operation on the audio content when the audio content scan result information is present and the version of the audio content scan result information is not a version compatible in the electronic device 201 (e.g., a version available in the electronic device 201). When the audio content scan result information is present and the version of the audio content scan result information is a version compatible in the electronic device 201 (e.g., a version available in the electronic device 201), the processor 220 according to an embodiment may identify whether the sound source information of the section requested by the user is included in the audio content scan result information.

The processor 220 according to an embodiment may scan the section requested by the user when the audio content scan result information is present and the version of the audio content scan result information is a version compatible in the electronic device 201 (e.g., a version available in the electronic device 201) and the sound source information of the section requested by the user is not included.

The processor 220 according to an embodiment may identify whether the section requested by the user is included in the skip interval when the audio content scan result information is present and the version of the audio content scan result information is a version compatible in the electronic device 201 (e.g., a version available in the electronic device 201), and sound source information of the section requested by the user is included.

The processor 220 according to an embodiment may perform a scan operation on the audio content when the audio content scan result information is present, and the version of the audio content scan result information is a version compatible in the electronic device 201 (e.g., a version available in the electronic device 201), sound source information of the section requested by the user is included, and the section requested by the user is included in the skip interval. The processor 220 according to an embodiment may extract sound source information about the user-requested section from the audio content scan result information and display the sound source information about the user-requested section on the display 260 if the audio content scan result information is present, and the version of the audio content scan result information is a version compatible in the electronic device 201 (e.g., a version available in the electronic device 201), and if the section requested by the user is not included in the skip interval.

The memory 230 (e.g., the memory 130 of FIG. 1) according to an embodiment may store a plurality of applications (functions or programs) and data associated with each of the plurality of applications. The memory 230 according to an embodiment may store various data generated during the execution of the program 140, as well as a program (e.g., the program 140 of FIG. 1) used for an audio separation operation and/or an audio scan operation during content playback. The memory 230 according to an embodiment may include a decoder 232, an audio solution 234, and an audio renderer 236, which are used for the audio separation operation and/or the audio scan operation during content playback of the disclosure. Although an example is described in which the decoder 232, the audio solution 234, and/or the audio renderer 236 according to an embodiment are stored as a software module, but each may be separately mounted as a physical component. The memory 230 according to an embodiment may include a program area (e.g., 140) and a data area. The program area (e.g., 140) may store related program information for driving the electronic device 201, such as an operating system (OS) (e.g., the operating system (e.g., 142) of FIG. 1) for booting the electronic device 201. The data area (not illustrated) may refer to at least one buffer according to various embodiments, and may store information (or data) obtained (or generated) in an audio separation operation and/or an audio scan operation during content playback. The memory 230 may include at least one storage medium of a flash memory, a hard disk, a multimedia card, a micro-type memory (e.g., a secure digital (SD) or an extreme digital (xD) memory), a random access memory (RAM), or a read only memory (ROM).

The audio output module 255 (e.g., the audio output module 155 of FIG. 1) according to an embodiment may convert the rendered audio data, output through the audio renderer 236, into an analog audio signal and output the analog audio signal through a speaker. For example, the audio output module 255 may include a speaker.

The communication module 290 (e.g., the communication module 190 of FIG. 1) according to an embodiment may communicate with the first external electronic device (e.g., the electronic device 104 of FIG. 1). For example, the communication module 290 may receive content from an external electronic device or transmit, to the external electronic device, information (e.g., scan result information of audio content) obtained through an audio separation operation and/or an audio scan operation during content playback. According to an embodiment, the communication module 290 may include a cellular module, a wireless-fidelity (Wi-Fi) module, a Bluetooth module, or a near field communication (NFC) module. Further, another module capable of communicating with the first external electronic device 204 may be further included.

The display 260 (e.g., the display module 160 of FIG. 1) according to an embodiment may display various types of information based on the control of the processor 220. For example, the display 260 may display a screen associated with performing an audio separation operation and/or a screen associated with an audio scan operation during content playback of the disclosure. According to an embodiment, the display 260 may be implemented in the form of a touch screen. When the display 260 is implemented together with the input module in the form of a touch screen, the display 260 may display various pieces of information generated according to the user's touch.

According to an embodiment, the electronic device 201 is not limited to the configuration illustrated in FIG. 2 and may further include various components. In an embodiment, major components of the electronic device 201 have been described above in connection with FIG. 2. According to an embodiment, however, all of the components of FIG. 2 are not essential components, and the electronic device 201 may be implemented with more or less components than those shown. Further, the connection relationship between the main components of the electronic device 201 described above with reference to FIG. 2 may be changed according to various embodiments.

An electronic device (e.g., the electronic device 101 of FIG. 1 or the electronic device 201 of FIG. 2) according to an embodiment may include a display 160, 260, an audio output module 155, 255, memory 130, 230 storing instructions, and at least one processor 120, 220. The instructions may, when executed by the at least one processor 220 individually or collectively, cause the electronic device 201 to, based on an input for scanning audio content, determine a first scan interval by using a time period corresponding to the audio content so that a scan time for the audio content does not exceed a specified maximum scan time and the specified maximum scan time, and scan the audio content by sampling audio data corresponding to the audio content by using the first scan interval. The instructions may, when executed by the at least one processor 220 individually or collectively, cause the electronic device 201 to, based on an input for playing the audio content, identify audio data of first plurality of sound sources corresponding to first audio data of a first time period among the audio data corresponding to the audio content by using a result of the scanning while playing the audio data corresponding to the audio content, obtain the audio data of the first plurality of the sound sources by performing separation of the first audio data of the first time period using a real time factor value, and output the audio data of the first plurality of sound sources through the audio output module.

According to an embodiment, the instructions may, when executed by the at least one processor 220 individually or collectively, cause the electronic device 201 to identify a first separation time to be needed to perform the separation of the first audio data of the first time period. According to an embodiment, the instructions may, when executed by the at least one processor 220 individually or collectively, cause the electronic device 201 to, when a size of audio data of first plurality of sound sources obtained by performing the separation of the first audio data of the first time period is equal to or larger than a data size corresponding to a first audio rendering time associated with the first separation time, transmit the audio data of the first plurality of sound sources to an audio renderer, and output the audio data of the first plurality of sound sources through the audio output module.

According to an embodiment, the instructions may, when executed by the at least one processor 220 individually or collectively, cause the electronic device 201 to, when the size of the audio data of the first plurality of sound sources is smaller than the data size corresponding to the first audio rendering time associated with the first separation time, store the audio data of the first plurality of sound sources in a first buffer of the memory. According to an embodiment, the instructions may, when executed by the at least one processor 220 individually or collectively, cause the electronic device 201 to obtain audio data of second plurality of sound sources by performing separation on second audio data of a second time period following the first time period. According to an embodiment, the instructions may, when executed by the at least one processor 220 individually or collectively, cause the electronic device 201 to, when the audio data of the first plurality of sound sources exists in the first buffer, merge the audio data of the first plurality of sound sources and the audio data of the second plurality of sound sources and transmit the merged audio data to the audio renderer 236 to output through the audio output module 255.

According to an embodiment, the instructions may, when executed by the at least one processor 220 individually or collectively, cause the electronic device 201 to obtain the real time factor value by using a value obtained by dividing separation time taken when the electronic device 201 has performed separation before the first audio data of the first time period by the first time period. According to an embodiment, the instructions may, when executed by the at least one processor 220 individually or collectively, cause the electronic device 201 to identify a cumulative average value of a plurality of real time factor values obtained when performing separation for each of a plurality of audio data before the first audio data of the first time period. According to an embodiment, the instructions may, when executed by the at least one processor 220 individually or collectively, cause the electronic device 201 to identify the first separation time by using the cumulative average value of the plurality of real time factor values and the status information of the electronic device 201.

According to an embodiment, the status information of the electronic device 201 may include at least one of usage amount of the at least one processor 220 and/or the memory, an occupancy rate of the at least one processor 220 and/or the memory, power consumption of a battery of the electronic device 201, information of an application which is running in a background of the electronic device 201, or information of network connection status of the electronic device 201.

According to an embodiment, the instructions may, when executed by the at least one processor 220 individually or collectively, cause the electronic device 201 to, when the separation of the first audio data of the first time period is not performed, store the first audio data of the first time period in a second buffer of the memory 130, 230. According to an embodiment, the instructions may, when executed by the at least one processor 220 individually or collectively, cause the electronic device 201 to, when the first audio data exists in the second buffer when the audio data of the second plurality of sound sources is obtained by performing the separation of the second audio data of the second time period, merge the first audio data and the audio data of the second plurality of sound sources, transmit the merged the first audio data and the audio data of the second plurality of sound sources to the audio renderer 236 to output the merged first audio data and the audio data of the second plurality of sound sources through the audio output module 255.

According to an embodiment, the audio content may comprise first audio content including the first audio data of the first time period and second content including the second audio data of the second time period. According to an embodiment, the instructions may, when executed by the at least one processor 220 individually or collectively, cause the electronic device 201 to identify whether the first audio data of the first time period and the second audio data of the second time period are continuous. According to an embodiment, the instructions may, when executed by the at least one processor 220 individually or collectively, cause the electronic device 201 to, when the first audio data of the first time period and the second audio data of the second time period are continuous, update first inference data by accumulating separation result information for the second audio content to follow separation result information for the first audio content without initializing the first inference data that has accumulated separation result information for the first audio content. According to an embodiment, the instructions may, when executed by the at least one processor 220 individually or collectively, cause the electronic device 201 to, when the first audio data of the first time period and the second audio data of the second time period are not continuous, reset the first inference and obtain second inference data that has accumulated separation result information for the second audio content.

According to an embodiment, the instructions may, when executed by the at least one processor 220 individually or collectively, cause the electronic device 201 to obtain the time period corresponding to the audio content, first status information of the electronic device 201, and the specified maximum scan time. According to an embodiment, the instructions may, when executed by the at least one processor 220 individually or collectively, cause the electronic device 201 to determine the first scan interval and a first skip interval by using the time period corresponding to the audio content, the first status information of the electronic device 201, and the specified maximum scan time so that the scan time for the audio content does not exceed the specified maximum scan time. According to an embodiment, the instructions may, when executed by the at least one processor 220 individually or collectively, cause the electronic device 201 to obtain audio data of a first section among the audio data corresponding to the audio content by decoding the audio content through a decoder. According to an embodiment, the instructions may, when executed by the at least one processor 220 individually or collectively, cause the electronic device 201 to sample at least part of the audio data of the first section by using the first scan interval and the first skip interval. According to an embodiment, the instructions may, when executed by the at least one processor 220 individually or collectively, cause the electronic device 201 to identify a sound source category of the audio data of the first section by analyzing the at least part of the audio data of the first section.

According to an embodiment, the instructions may, when executed by the at least one processor 220 individually or collectively, cause the electronic device 201 to obtain second status information of the electronic device 201 for scanning audio data of a second section following the audio data of the first section among the audio data corresponding to the audio content. According to an embodiment, the instructions may, when executed by the at least one processor 220 individually or collectively, cause the electronic device 201 to obtain an expected decoding time needed for decoding the audio data of the second section. According to an embodiment, the instructions may, when executed by the at least one processor 220 individually or collectively, cause the electronic device 201 to obtain a scan time needed for scanning audio data of a specified time section. According to an embodiment, the instructions may, when executed by the at least one processor 220 individually or collectively, cause the electronic device 201 to identify a longer time among the expected decoding time and the scan time as an expected scan time for the audio data of the specified time section. According to an embodiment, the instructions may, when executed by the at least one processor 220 individually or collectively, cause the electronic device 201 to determine a second scan interval and a second skip interval of the audio data of the second section based on the expected scan time, the second status information of the electronic device 201, and the specified maximum scan time. According to an embodiment, the instructions may, when executed by the at least one processor 220 individually or collectively, cause the electronic device 201 to sample at least part of the audio data of the second section by using the second scan interval and the second skip interval. According to an embodiment, the instructions may, when executed by the at least one processor 220 individually or collectively, cause the electronic device 201 to identify a sound source category of the audio data of the second section by analyzing the at least part of the audio data of the second section.

According to an embodiment, the instructions may, when executed by the at least one processor 220 individually or collectively, cause the electronic device 201 to, when a first sampling type is specified for sampling using the second scan interval and the second skip interval, calculate a starting point of the second section based on the second scan interval.

According to an embodiment, the instructions may, when executed by the at least one processor 220 individually or collectively, cause the electronic device 201 to obtain the audio data of the second section by decoding from the starting point of the second section by using the decoder. According to an embodiment, the instructions may, when executed by the at least one processor 220 individually or collectively, cause the electronic device 201 to sample at least part of the audio data of the second section by using the second scan interval and the second skip interval.

According to an embodiment, the instructions may, when executed by the at least one processor 220 individually or collectively, cause the electronic device 201 to, when a second sampling type is specified for sampling using the second scan interval and the second skip interval, obtain the audio data of the second section of the audio content by using the decoder. According to an embodiment, the instructions may, when executed by the at least one processor 220 individually or collectively, cause the electronic device 201 to sample at least part of the audio data of the second section corresponding to the second scan interval.

FIG. 3 is a block diagram illustrating an audio separator according to an embodiment.

Referring to FIG. 3, the audio separator 24 according to an embodiment may be stored in the memory 230 as a software module (or program). According to an embodiment, the audio separator 24 may be implemented as a hardware module (or a component or hardware element).

The audio separator 24 according to an embodiment may separate at least one sound source audio data corresponding to a sound source (e.g., vocal, musical instrument, background sound, noise, and/or other sound sources) of at least one designated category (or classification criterion) from audio data (PCM data) of a predetermined period (or a duration) obtained from audio content and obtain (or output) at least one separated sound source audio data.

The audio separator 24 according to an embodiment may include a separation time estimator 310, a separator 320, an audio data scheduler 330, an audio buffer manager 340, device utilities 350, a content manager 360, and/or an audio processor module 360.

The processor 220 according to an embodiment may measure and store the separation times (actually needed) each time audio separation is performed on audio data in the electronic device 201 using the separation time estimator 310. The processor 220 according to an embodiment may obtain the real time factor value based on the separation times stored using the separation time estimator 310 and Equations 1 and 2, and identify the (real time) separation time (e.g., the separation time needed to perform separation on the current separation target audio data) based on the real time factor value.

The processor 220 according to an embodiment may perform separation on the audio data through the separator 320. According to an embodiment, the processor 220 may receive, through the separator 320, the PCM data of the first time (e.g., minimum analysis (or separation) duration)) period (e.g., 2 seconds) obtained by collecting a designated amount (e.g., a designated PCM data amount for performing separation) of PCM data of a designated time (e.g., 0.5 seconds) through the decoder 232 and perform separation on the first audio data of the first time period to obtain a first plurality of sound source audio data. The processor 220 according to an embodiment may obtain (or output) a first plurality of sound source audio data by performing separation of individually extracting a plurality of sound sources (e.g., vocal, musical instrument, background sound, noise, and/or other sources) from the first audio data of the first time period through the separator 320. For example, separation may be sound source separation. The processor 220 according to an embodiment may perform sound source separation using a designated number of pieces of classification information through the separator 320, and the designated number may not be limited to a specific number. The processor 220 according to an embodiment may adjust the calculation speed through the separator 320 according to the status information about the electronic device 201.

The processor 220 according to an embodiment determines whether the size (current audio output PCM data) of the first plurality of sound source audio data output from the separator 320 is sufficient (data size) to perform audio rendering until the next second plurality of sound source audio data (separation output data) is output based on the separation time (e.g., the first separation time) calculated in real time using the audio data scheduler 330. The processor 220 according to an embodiment may determine whether the data size of the first plurality of sound source audio data obtained from the separator 350 is equal to or larger than the size of audio data corresponding to the first audio rendering time (or the first playback time) associated with the first separation time based on the first separation time using the audio data scheduler 330.

According to an embodiment, the first audio rendering time may be the time needed to perform audio rendering (or play) audio data prepared for audio rendering in a buffer (e.g., a first buffer, an output buffer, or a buffer that stores audio data to be input to the audio renderer 236). For example, if the data size of the first plurality of sound source audio data is equal to or larger than the size of the audio data corresponding to the first audio rendering time associated with the first separation time, the amount of the first plurality of sound source audio data audio-rendered is not insufficient when separating the second time period following the first time period, so that no audio drop may occur between the audio output for the first plurality of sound source audio data and the audio output for the second plurality of sound source audio data. For example, if the data size of the first plurality of sound source audio data is not equal to or larger than (or is smaller than) the size of the audio data corresponding to the first audio rendering time associated with the first separation time, the amount of the first plurality of sound source audio data audio-rendered may become insufficient when the second audio data is being separated, resulting in an audio drop between the audio output for the first plurality of sound source audio data and the audio output for the second plurality of sound source audio data. If the data size of the first plurality of sound source audio data obtained from the separator 350 is insufficient compared with the data (audio output PCM data) size of the first separation time (or the first audio rendering time associated with the first separation time), the processor 220 according to an embodiment does not transmit the first plurality of sound source audio data to the audio renderer 236 (or rendering phase) but maintain the same (store in a buffer) and merge them with the first plurality of sound source audio data next obtained from the separator 350, thereby performing scheduling (managing the data flow) to prevent an audio drop based on the real time factor value using the audio data scheduler 320. The processor 220 according to an embodiment may perform scheduling whenever separation is performed using the audio data scheduler 320. When the data size of the first plurality of sound source audio data obtained from the separator 350 according to an embodiment is smaller than the data (audio output PCM data) size of the first separation time (or the first audio rendering time associated with the first separation time) may be a case where, during the initial separation operation (when there is no plurality of sound source audio data previously obtained by the previous separation operation), the size of the last audio data of the first audio content may be smaller than the data size corresponding to the separation time according to the real-time factor value, when playing discontinuous first and second audio content.

The processor 220 according to an embodiment may determine the level of parallelizing the audio processing operation (e.g., volume control and mixing of the plurality of separated sound source audio data) using the audio processing module 370 and the separation operation using the separator, according to the processor (e.g., GPU) overhead and scan time that occur when performing the separation operation through the separator 320 via the audio buffer manager 340. When the performance of the electronic device 201 is lower than the designated performance, if the frequency of simultaneously performing the audio processing operation and the separation operation increases, excessive process occupation may affect other operations within the electronic device 201. To prevent this, the processor 220 according to an embodiment may control the audio processing operation and the separation operation to be performed linearly through the audio buffer manager 340 when the separation time is fast enough, thereby lowering the maximum value of the average usage of the processor 220. When the overhead needs to be reduced, the processor 220 according to an embodiment controls the audio processing operation and the separation operation to be performed in parallel using a buffer handling method through the audio buffer manager 340, and during the separation operation, lower the usage of the processor 220 (e.g., GPU) only to the extent that there is no problem with audio rendering, thereby achieving optimization. The processor 220 according to an embodiment may select or distinguish audio content to be separated from among a plurality of audio content through the audio buffer manager 340 when playing content that includes a plurality of audio content. When the audio data of audio content to be separated and the audio data of audio content not to be separated are continuously obtained, the processor 220 according to an embodiment may handle them to be separately processed in different buffers (e.g., a separable buffer and a non-separable buffer) through the audio buffer manager 340. This may enhance processing speed and reduce the average occupancy rate of the processor 220 (e.g., GPU) by preventing the audio data of audio content not to be separated from being transmitted (or input) to the separator 350.

The processor 220 according to an embodiment may obtain real time (current) status information about the electronic device 201 through the device utilities 350. The processor 220 according to an embodiment may obtain, through the device utilities 350, the current usage amount and/or occupancy rate of the CPU, AP, and/or audio processor and/or memory 230 of the electronic device 201, power consumption of the battery (e.g., 189 of FIG. 1) of the electronic device 201, an application running in the background of the electronic device 201, and/or network connection status information about the electronic device 201.

The processor 220 according to an embodiment may determine whether to maintain the inference data stored by accumulating the separation results of the audio content in the separator 330 according to the association (e.g., whether they are continuous) between the plurality of audio data (e.g., continuous audio content added to one timeline in the editor) included in the content requested to be played (or edited) through the content manager 360.

According to an embodiment, when the processor 220 performs separation on the first audio content and then performs separation on the second audio content through the content manager 360, if the first audio content and the second audio content do not have continuity, the processor 220 may designate a flag for terminating the first inference data accumulated for the first audio content to terminate (or reset) the first inference data and then obtain and use the second inference data that accumulates the separation result information for the second audio content. According to an embodiment, when the processor 220 performs separation on the first audio content and then performs separation on the second audio content through the content manager 360. If the first audio content and the second audio content have continuity, the processor 220 may, rather initializing the first inference data accumulating the separation result information for the first audio content, further accumulate the separation result information for the second audio content following the separation result information for the first audio content to update the first inference data. When the first audio content and the second audio content have the same content path and reference, and the end time of the first audio content and the start time of the next second audio content are within an allowable error value, the processor 220 according to an embodiment may determine that the first audio content and the second audio content have continuity although they are separated (e.g., determining that it is the case where the same content has simply been split), to prevent the first inference data from being terminated or reset, through the content manager 360.

The processor 220 according to an embodiment may adjust the volume of each of the plurality of sound source audio data (e.g., the first plurality of sound source audio data or the merged first and second plurality of sound source audio data), as a separation result obtained using the separator 330, to a designated volume level (e.g., a volume designated by the user or automatically (e.g., in the case of noise cancelation, the volume designated to the noise sound source audio data: 0), through the audio processor module 360. The processor 220 according to an embodiment may mix the first plurality of sound source audio data adjusted in volume and transmit the mixed first plurality of sound source audio data to the audio renderer 236, through the audio processor module 360.

The processor 220 according to an embodiment may audio-render the mixed first plurality of sound source audio data through the audio renderer 236 and output the same through the audio output module 255. The processor 220 according to an embodiment may obtain the audio data for audio rendering by separating and/or merging the mixed first plurality of sound source audio data according to the audio data unit independent of the separation operation through the audio renderer 236, and output the obtained audio data through the audio output module 255. The processor 220 according to an embodiment may change audio attributes including the channel, the sampling rate, and/or the speed of audio data for audio rendering, if necessary.

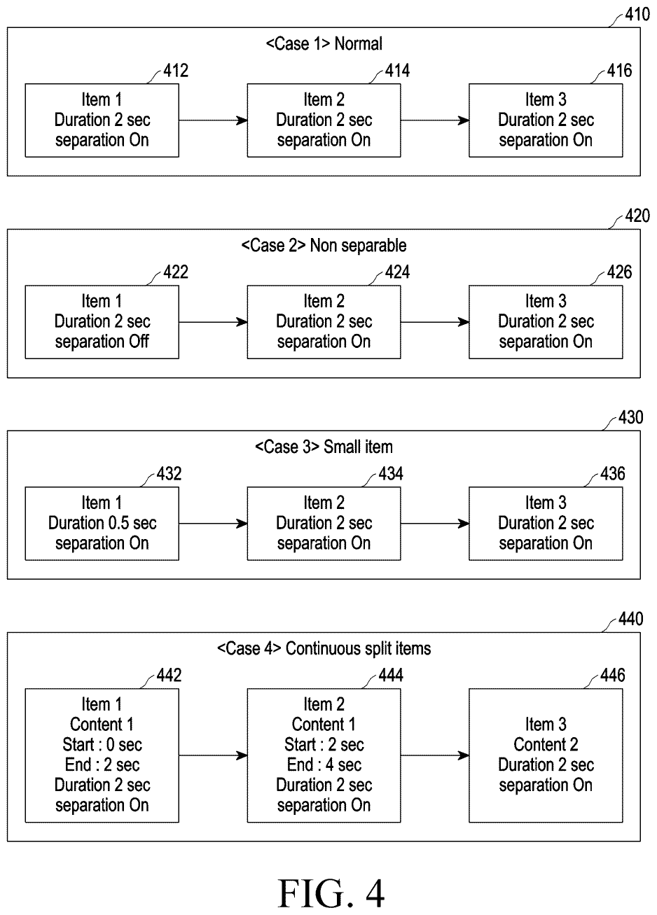

FIG. 4 is a view illustrating separation processing cases of content including a plurality of audio contents in an electronic device according to an embodiment.

Referring to FIG. 4, the first case (<case 1> normal) 410 according to an embodiment may indicate a case where the content includes item1 audio content 412, item2 audio content 414, and item3 audio content 416 that are continuous and different from each other, and the audio data size (e.g., duration 2 sec) obtained from each of item1 audio content 412, item2 audio content 414, and item3 audio content 416 is not smaller than the data size (e.g., duration 2 sec) to be prepared for audio rendering. The processor 220 according to an embodiment may perform separation while sequentially playing the item1 audio content 412, the item2 audio content 414, and the item3 audio content 416 according to a content playback request in the first case 410. The processor 220 according to an embodiment may perform audio data separation on the first section of audio data obtained by decoding the item1 audio content 412 to obtain a first pcm output (e.g., a plurality of sound source audio data), and store the same in the first buffer to delay audio rendering on the first pcm output because there is no data prepared for audio rendering when the first pcm output is obtained. The processor 220 according to an embodiment may perform audio rendering on the next pcm outputs without delay because data prepared for audio rendering may be sufficient from the audio data separation operation on the next section of the first section. The processor 220 according to an embodiment may reset the inference data through the content manager 360 when the separation of the item1 audio content 412, the item2 audio content 414, and the item3 audio content 416 starts because the item1 audio content 412, the item2 audio content 414, and the item3 audio content 416 are different contents.

The second case (<case 2> non separable) 420 according to an embodiment may indicate a case where the content includes item1 audio content 422, item2 audio content 424, and item3 audio content 426 that are continuous and different from each other, and the item1 audio content 422 is designated (or set) not to be performed (designated not to be desired to be separated by the user), the item2 audio content 424 and the item3 audio content 426 are set to be separated, and the audio data size (e.g., duration 2 sec) from each of the item1 audio content 422, the item2 audio content 424, and the item3 audio content 426 is not smaller than the data size (e.g., duration 2 sec) to be prepared for audio rendering. in the second case 420, the processor 220 according to an embodiment may sequentially play the item1 audio content 422, the item2 audio content 424, and the item3 audio content 426 in response to a content playback request while storing the audio data of the item1 audio content 422 in the buffer (e.g., the second buffer) without performing separation on it, and sequentially separating the audio data of the item2 audio content 424 and the item3 audio content 426. The processor 220 according to an embodiment may schedule the audio data of the item1 audio content 422 stored in the buffer through the audio data scheduler 330 to be transmitted to the audio processor module 370 before the audio data of the item2 audio content 424 is separated and before pcm outputs (e.g., the plurality of sound source audio data).

The third case (<case 3> small item) 430 according to an embodiment may indicate a case where the content item1 audio content 432, item2 audio content 434, and item3 audio content 436 that are continuous and different from each other, and the audio data size (e.g., duration 0.5 sec) from the item1 audio content 432 is smaller than the data size (e.g., duration 2 sec) to be prepared for audio rendering, and the data size (e.g., duration 2 sec) from each of the item2 audio content 434 and item3 audio content 436 is not smaller than the data size (e.g., duration 2 sec) to be prepared for audio rendering. The processor 220 according to an embodiment may perform separation while sequentially playing the item1 audio content 432, the item2 audio content 434, and the item3 audio content 436 according to a content playback request in the third case 430. Since the audio data size (e.g., duration 0.5 sec) from the item1 audio content 432 is smaller than the data size (e.g., duration 2 sec) to be prepared for audio rendering, the processor 220 according to an embodiment may experience a shortage of audio data to be prepared for rendering at the time of separating the audio data of the item2 audio content 434. The processor 220 according to an embodiment may store the pcm outputs (e.g., a plurality of sound source audio data) obtained after performing separation from the item1 audio content 432 in the buffer (e.g., the first buffer) to delay and, if obtaining the next pcm outputs (e.g., a plurality of sound source audio data) after the audio data separation operation of the next item2 audio content 434, allow the pcm outputs stored in the buffer and the next pcm outputs to be merged and audio-rendered.

The fourth case (<case 4> continuous split item) 440 according to an embodiment may indicate a case where the content includes the item1 audio content 442 and the item2 audio content 444 which are continuous and identical but are split, and the item3 audio content that is different from the item1 audio content 442 and the item2 audio content 444, and the audio data size (e.g., duration 2 sec) from each of the item1 audio content 442, the item2 audio content 444, and the item3 audio content 446 is not smaller than the data size (e.g., duration 2 sec) to be prepared for audio rendering. The processor 220 according to an embodiment may perform separation while sequentially playing the item1 audio content 442, the item2 audio content 444, and the item3 audio content 446 according to a content playback request in the fourth case 440. When performing separation on the item1 audio content 442 and separating the item2 audio content 444, since the item1 audio content 442 and the item2 audio content 444 are identical but are split, the processor 220 according to an embodiment may not reset the inference data when separation of the item2 audio content 444 starts.

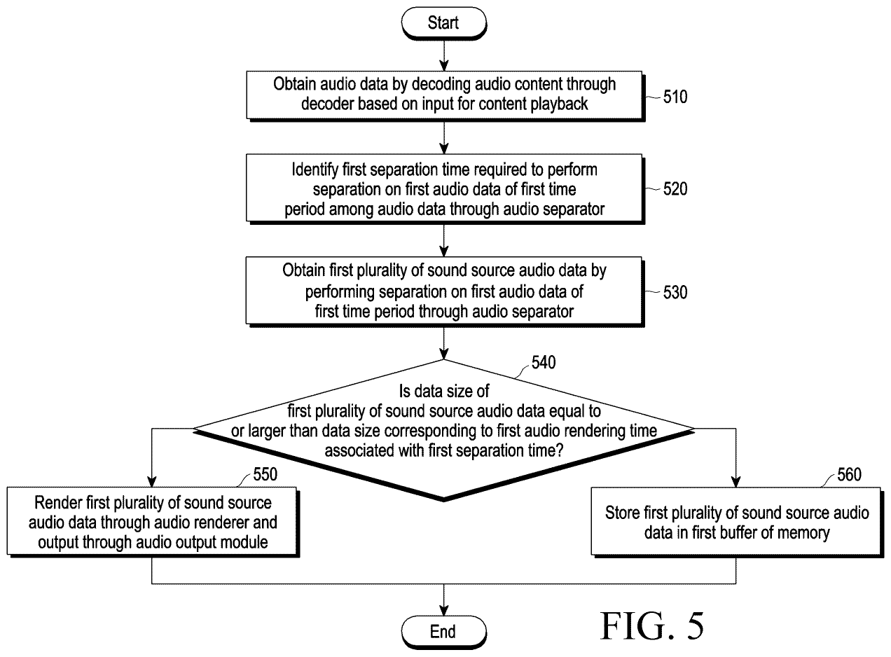

FIG. 5 is a flowchart illustrating an audio data separation operation when playing content according to an embodiment.

Referring to FIG. 5, the processor of the electronic device (e.g., the electronic device 101 of FIG. 1 or the electronic device 201 of FIG. 2) according to an embodiment (e.g., the processor 120 of FIG. 1 or the processor 220 of FIG. 2) may perform at least one of operations 510 to 560.

In operation 510, the processor 220 according to an embodiment may obtain audio data by decoding audio content (e.g., the audio stream) through the decoder 232 based on an input for playing content. Content according to an embodiment may include audio content or may include audio content and video content. The audio content according to an embodiment may include first audio content and second audio content. The first audio content and the second audio content according to an embodiment may be continuous and different audio content. The processor 220 according to an embodiment may display a screen for playing (or editing) content on the display 260 based on the execution of a content playback application (or content editing application) (or program). The processor 220 according to an embodiment may identify an input for playing content based on a user input to a button (or icon) for requesting playback on the screen for playing content. The processor 220 according to an embodiment may obtain audio data (e.g., audio pulse code modulation (PCM) data) by decoding the audio content through the decoder 232 based on identifying an input for playing the content. The processor 220 according to an embodiment may decode audio content through the decoder 232 to continuously output (or obtain) PCM data having a designated duration (e.g., 0.5 seconds).

In operation 520, the processor 220 according to an embodiment may identify a first separation time needed to perform separation on the first audio data (e.g., input PCM data of the audio separator 24) of the first time period among the audio data through the audio separator 24. For example, the processor 220 may obtain the PCM data of the first time period (e.g., 2 seconds) obtained by collecting a designated amount (e.g., a designated PCM data amount for performing separation) of PCM data of a designated time (e.g., 0.5 seconds) output (or obtained) through the decoder 232 as the first audio data of the first time period which is the input PCM data for performing separation through the audio separator 24. The processor 220 according to an embodiment may obtain (or calculate) the first time period (e.g., PCM input duration) corresponding to the input PCM data based on Equation 1 above and identify the first separation time to be needed to perform separation on the input PCM data of the first time period based on Equation 2 above. The processor 220 according to an embodiment may obtain the real time factor value by using a value obtained by dividing the separation time, which is the actual separation time taken when the electronic device 201 has performed separation before the first audio data of the first time period by the first time period. The processor 220 according to an embodiment may identify the first separation time needed to perform separation on the first audio data of the first time period using the real time factor value. The processor 220 according to an embodiment may obtain a cumulative average of previous real time factor values obtained when separating each of the plurality of audio data before the first audio data of the first time period and identify the first separation time for the first audio data of the first time period using the cumulative average of the real time factor values. The processor 220 according to an embodiment may obtain a cumulative average of previous real time factor values obtained when separating each of the plurality of audio data before the first audio data of the first time period, and identify the first separation time for the first audio data of the first time period using the cumulative average of the real time factor values and the status information about the electronic device. The status information about the electronic device 201 according to an embodiment may include the usage amount and/or occupancy rate of at least one processor 220 (e.g., CPU, AP, and/or audio processor) and/or memory 230, power consumption of the battery (e.g., 189 of FIG. 1) of the electronic device 201, an application running in the background of the electronic device 201, and/or network connection status information about the electronic device 201.

In operation 530, the processor 220 according to an embodiment may obtain a first plurality of sound source audio data by performing separation on the first audio data of the first time period through the audio separator 24. According to an embodiment, the processor 220 may transmit the PCM data of the first time (e.g., minimum analysis (or separation) duration)) period (e.g., 2 seconds) obtained by collecting a designated amount (e.g., a designated PCM data amount for performing separation) of PCM data of a designated time (e.g., 0.5 seconds) obtained through the decoder 232 to the audio separator 24 and perform separation on the first audio data of the first time period through the audio separator 24 to obtain a first plurality of sound source audio data. The processor 220 according to an embodiment may obtain a first plurality of sound source audio data by performing separation of individually extracting a plurality of sound sources (e.g., vocal, musical instrument, background sound, noise, and/or other sources) from the first audio data of the first time period through the audio separator 24. For example, separation may be sound source separation. The processor 220 according to an embodiment may perform sound source separation using a designated number of pieces of classification information through the audio separator 24, and the designated number may not be limited to a specific number.

In operation 540, the processor 220 according to an embodiment may determine whether the data size of the first plurality of sound source audio data is equal to or larger than the size of audio data corresponding to the first audio rendering time (or the first playback time) associated with the first separation time. According to an embodiment, the first audio rendering time may be the time needed to perform audio rendering (or play) audio data prepared for audio rendering in a buffer (e.g., a first buffer, an output buffer, or a buffer that stores audio data to be input to the audio renderer 236). The processor 220 according to an embodiment may determine whether the data size of the first plurality of sound source audio data is equal to or larger than the data size corresponding to the first audio rendering time associated with the first separation time. For example, if the data size of the first plurality of sound source audio data is equal to or larger than the size of the audio data corresponding to the first audio rendering time associated with the first separation time, the amount of the first plurality of sound source audio data audio-rendered is not insufficient when separating the second time period following the first time period, so that no audio drop may occur between the audio output for the first plurality of sound source audio data and the audio output for the second plurality of sound source audio data. For example, if the data size of the first plurality of sound source audio data is not equal to or larger than (or is smaller than) the size of the audio data corresponding to the first audio rendering time associated with the first separation time, the amount of the first plurality of sound source audio data audio-rendered may become insufficient when the second audio data is being separated, resulting in an audio drop between the audio output for the first plurality of sound source audio data and the audio output for the second plurality of sound source audio data.

In operation 550, the processor 220 according to an embodiment may perform audio rendering on the first plurality of sound source audio data through the audio renderer 236 and output the same through the audio output module 255 if the data size of the first plurality of sound source audio data is equal to or larger than the data size corresponding to the first audio rendering time associated with the first separation time. The processor 220 according to an embodiment may adjust the volume of each of the first plurality of sound source audio data before transmitting the first plurality of sound source audio data to the audio renderer 236. The processor 220 according to an embodiment may adjust the volume of each of the first plurality of sound source audio data to a volume level input by the user or a volume level automatically designated. For example, when the first plurality of sound source audio data includes voice sound source audio data and instrument sound source audio data, and the volume level is designated so that the volume of the voice sound source audio data is 56% by a user input or automatically, the processor 220 may adjust the volume level of the voice sound source audio data, among the first plurality of sound source audio data, to 56% and the volume level of the instrument sound source audio data to 100%. For example, when the first plurality of sound source audio data includes voice sound source audio data and noise sound source audio data, and it is designated that noise is removed by a user input or automatically, the processor 220 may adjust the volume level of the voice sound source audio data among the first plurality of sound source audio data to 100% and the volume level of the noise sound source audio data to 0%. The processor 220 according to an embodiment may display a content edit screen for designating (or changing) the volume level of each of the first plurality of sound source audio data and allow the volume level of at least some or all of the first plurality of sound source audio data to be designated (or changed) automatically or by a user input on the content edit screen. The processor 220 according to an embodiment may mix the first plurality of sound source audio data adjusted in volume and transmit the mixed first plurality of sound source audio data to the audio renderer 236. The processor 220 according to an embodiment may audio-render the mixed first plurality of sound source audio data through the audio renderer 236 and output the same through the audio output module 255.

In operation 560, if the data size of the first plurality of sound source audio data is smaller than the data size corresponding to the first audio rendering time associated with the first separation time, the processor 220 according to an embodiment may delay audio rendering for the first plurality of sound source audio data by storing the first plurality of sound source audio data in the first buffer (e.g., an output buffer or a buffer that stores audio data to be input to the audio renderer 236) without transmitting the first plurality of sound source audio data to the audio renderer 236. The processor 220 according to an embodiment may store a first plurality of sound source audio data in the first buffer, and then obtain a second plurality of sound source audio data by performing separation on the second audio data of the second time period after the first time period. The separation of the second audio data may be similar to the separation operation of the first audio data. When the second plurality of sound source audio data is obtained and the first plurality of sound source audio data is present in the first buffer, the processor 220 according to an embodiment may merge the first plurality of sound source audio data with the second plurality of sound source audio data. The processor 220 according to an embodiment may transmit the merged first plurality of sound source audio data and second plurality of sound source audio data to the audio renderer 236. The processor 220 according to an embodiment may adjust the volume of each of the first plurality of sound source audio data and the second plurality of sound source audio data, mix the first plurality of sound source audio data and the second plurality of sound source audio data having the adjusted volume, and transmit the mixed first plurality of sound source audio data and second plurality of sound source audio data to the audio renderer 236 to output the same through the audio output module 255. According to an embodiment, when the data size of the first plurality of sound source audio data is smaller than the size of the audio data corresponding to the first audio rendering time associated with the first separation time, the processor 220 stores the first plurality of sound source audio data in the first buffer and, when the next second plurality of sound source audio data is obtained, merge the first plurality of sound source audio data and the second plurality of sound source audio data and perform audio rendering. Thus, it is possible to prevent an audio drop from occurring between the audio output of the first plurality of sound source audio data and the audio output of the second plurality of sound source audio data due to insufficiency of the amount of the first plurality of sound source audio data audio-rendered when separation is performed on the second plurality of sound source audio data.

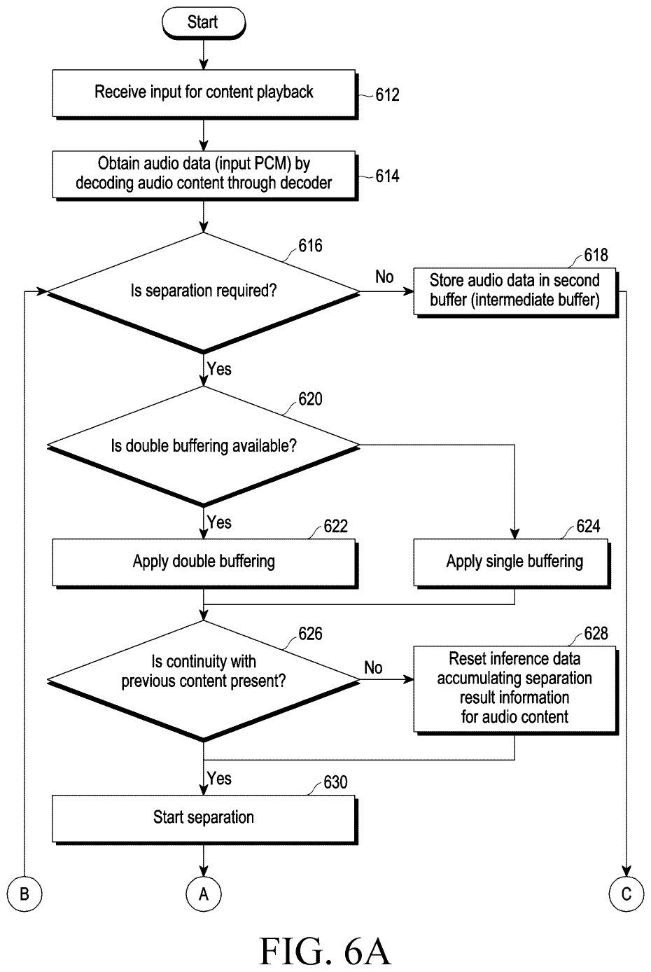

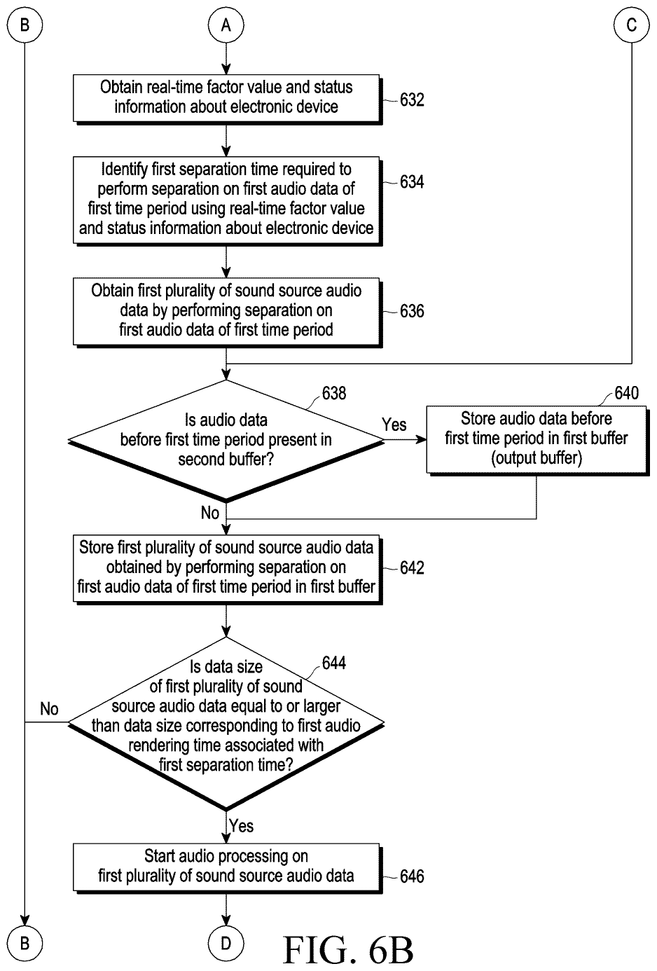

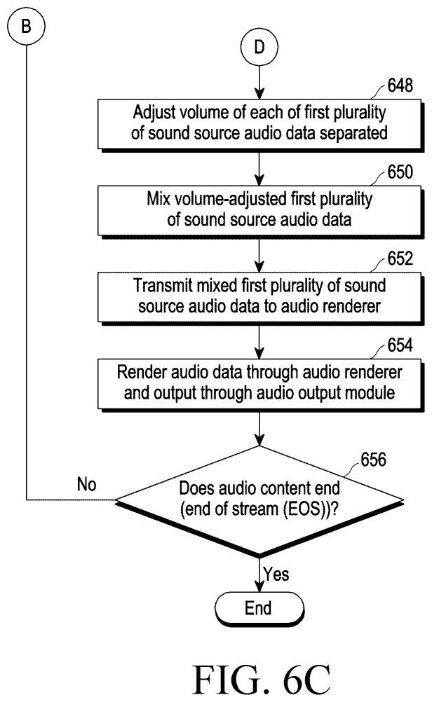

FIG. 6A is a flowchart illustrating an audio data separation operation according to whether audio data is audio data needed to be separated when content is played according to an embodiment. FIG. 6B is a flowchart illustrating operations continuing from 6A according to an embodiment. FIG. 6C is a flowchart illustrating operations continuing from 6b according to an embodiment.

Referring to FIG. 6A, the processor of the electronic device (e.g., the electronic device 101 of FIG. 1 or the electronic device 201 of FIG. 2) according to an embodiment (e.g., the processor 120 of FIG. 1 or the processor 220 of FIG. 2) may perform at least one of operations 612 to 656.

In operation 612, the processor 220 according to an embodiment may receive an input for playing content. The processor 220 according to an embodiment may display a screen for editing (or playing) content on the display 260 based on the execution of a content edit application (or content playback application) (or program). The processor 220 according to an embodiment may identify an input for playing content based on a user input to a button (or icon) for requesting playback on the screen for editing content.

In operation 614, the processor 220 according to an embodiment may obtain audio data (e.g., PCM data) by decoding audio content (e.g., the audio stream) through the decoder 232. For example, the audio stream may be content in the form for continuously transmitting digital audio data over time. Content according to an embodiment may include audio data or may include audio data and video data. The audio data according to an embodiment may include first audio data and second audio data. The first audio data and the second audio data according to an embodiment may be continuous but different audio data. PCM data according to an embodiment is a format representing digital audio data, and may be data obtained by sampling the amplitude of sound waves at specific time intervals to convert analog audio signals (sounds) into digital signals and representing them as discrete numbers. The unit of the PCM data according to an embodiment may be a sample. For example, PCM data size (e.g., bytes) during a predetermined duration (e.g., 1 second) may be calculated by multiplying the sampling rate, sample size, and channel count. The processor 220 according to an embodiment may decode audio content through the decoder 232 to obtain PCM data (e.g., input PCM data) having a designated duration (e.g., 0.5 seconds).

In operation 616, the processor 220 according to an embodiment may identify whether the audio data (PCM data) obtained through the decoder 232 is audio data needed to be separated. The processor 220 according to an embodiment may identify whether the audio content is audio content needed to be separated through the content manager 360 and, when it is the audio content needed to be separated, determine that the audio data (PCM data) is needed to be separated.

In operation 618, when the audio data is not needed to be separated, the processor 220 according to an embodiment may store it in a buffer (e.g., a second buffer or an intermediate buffer) designated to store audio data not needed to be separated. The processor 220 according to an embodiment may schedule the audio data stored in the second buffer to be transmitted to the audio renderer 236 to be audio-rendered in the time period corresponding to the stored audio data.

In operation 620, the processor 220 according to an embodiment may identify whether a plurality of buffers are available to process the audio data to be separated based on the status information about the electronic device 201. The processor 220 according to an embodiment may determine whether to use a single buffer (single buffering) or a plurality of buffers (double buffering) depending on the status information about the electronic device 201 and/or the presence of a delay in the separation operation through the audio separator 24.

In operation 622, when the status information about the electronic device 201 indicates that a plurality of buffers are available, and the separation operation is delayed, the processor 220 according to an embodiment may parallelize the audio data to be separated by applying a plurality of buffers (double buffering) through the audio buffer manager 340.

In operation 624, the processor 220 according to an embodiment may sequentially process the audio data to be separated by applying one buffer (single buffering) through the audio buffer manager 340 when the status information about the electronic device 201 indicates that the plurality of buffers are not available or the separation operation is not delayed.

In operation 626, the processor 220 according to an embodiment may identify whether the audio content of the audio data has continuity with the audio content of the previous audio data. The processor 220 according to an embodiment may identify whether the audio content of the audio data has continuity with the audio content of the previous audio data through the content manager 360.

In operation 628, when the audio content of the audio data does not have continuity with the audio content of the previous audio data, the processor 220 according to an embodiment may reset the inference data accumulating the separation result information for the audio content and perform operation 630. The processor 220 according to an embodiment may request the separator 320 to set the inference data accumulating the separation result information for the audio content through the content manager 360. When the audio content of the audio data has continuity with the audio content of the previous audio data, the processor 220 according to an embodiment does not reset the inference data accumulating the separation result information for the audio content but may perform operation 630.

In operation 630, the processor 220 according to an embodiment may start a separation operation on the audio data. The processor 220 according to an embodiment may start the separation operation on the audio data through the separator 320.

In operation 632, the processor 220 according to an embodiment may obtain a real time factor value and status information about the electronic device 201. The processor 220 according to an embodiment may obtain the real time factor value by using a value obtained by dividing the actual separation time taken when the electronic device 201 has performed separation before the current audio data to be separated (e.g., the first audio data of the first time period) by the first time period. The processor 220 according to an embodiment may obtain the status information (e.g., first status information) about the electronic device 201 through the device utilities 350. The status information about the electronic device 201 according to an embodiment may include the usage amount and/or occupancy rate of at least one processor 220 (e.g., CPU, AP, and/or audio processor) and/or memory 230, power consumption of the battery (e.g., 189 of FIG. 1) of the electronic device 201, an application running in the background of the electronic device 201, and/or network connection status information about the electronic device 201.

In operation 634, the processor 220 according to an embodiment may identify the first separation time needed to perform separation on the first audio data of the first time period using the real time factor value and the status information about the electronic device. The processor 220 according to an embodiment may obtain a cumulative average of previous real time factor values obtained when separating each of the plurality of audio data before the first audio data of the first time period and identify the first separation time for the first audio data of the first time period using the cumulative average of the real time factor values. The processor 220 according to an embodiment may obtain a cumulative average of previous real time factor values obtained when separating each of the plurality of audio data before the first audio data of the first time period, and identify the first separation time for the first audio data of the first time period using the cumulative average of the real time factor values and the status information about the electronic device.

In operation 636, the processor 220 according to an embodiment may obtain a first plurality of sound source audio data by performing separation on the first audio data of the first time period through the audio separator 24. According to an embodiment, the processor 220 may transmit the PCM data of the first time (e.g., minimum analysis (or separation) duration)) period (e.g., 2 seconds) obtained by collecting a designated amount (e.g., a designated PCM data amount for performing separation) of PCM data of a designated time (e.g., 0.5 seconds) obtained through the decoder 232 to the audio separator 24 and perform separation on the first audio data of the first time period through the audio separator 24 to obtain a first plurality of sound source audio data. The processor 220 according to an embodiment may obtain a first plurality of sound source audio data by performing separation of individually extracting a plurality of sound sources (e.g., vocal, musical instrument, background sound, noise, and/or other sources) from the first audio data of the first time period through the audio separator 24. For example, separation may be sound source separation. The processor 220 according to an embodiment may perform sound source separation using a designated number of pieces of classification information through the audio separator 24, and the designated number may not be limited to a specific number.

In operation 638, the processor 220 according to an embodiment may identify whether audio data before the first time period is present in a designated buffer (e.g., the second buffer).

In operation 640, when the audio data before the first time period is present in the designated buffer (e.g., the second buffer), the processor 220 may store (or merge) the audio data before the first time period in the first buffer (e.g., the output buffer or the buffer storing the audio data to be input to the audio renderer 236) of the memory 230.

In operation 642, when the audio data before the first time period is not present in the designated buffer (e.g., the second buffer), the processor 220 according to an embodiment may store, in the first buffer, the first plurality of sound source audio data obtained by performing separation on the first audio data of the first time period.

In operation 644, the processor 220 according to an embodiment may determine whether the data size of the first plurality of sound source audio data is equal to or larger than the size of audio data corresponding to the first audio rendering time (or the first playback time) associated with the first separation time. According to an embodiment, the first audio rendering time may be a time needed to audio-render (or play) the audio data prepared for audio rendering in the first buffer.

In operation 646, if the data size of the first plurality of sound source audio data is equal to or larger than the data size corresponding to the first audio rendering time associated with the first separation time, the processor 220 according to an embodiment may transmit the first plurality of sound source audio data to the audio processing module 370 to start audio processing on the first plurality of sound source audio data. If the data size of the first plurality of sound source audio data is smaller than the data size corresponding to the first audio rendering time associated with the first separation time, the processor 220 according to an embodiment may return to operation 616 to perform separation on the second audio data of the later second time period and merge and process the first plurality of sound source audio data and the second plurality of sound source audio data which is the separation result of the audio data of the second time period.

In operation 648, the processor 220 according to an embodiment may adjust the volume of each of the separated first plurality of sound source audio data. The processor 220 according to an embodiment may adjust the volume of each of the first plurality of sound source audio data to a volume level input by the user or a volume level automatically designated, through the audio processing module 370. For example, when the first plurality of sound source audio data includes voice sound source audio data and instrument sound source audio data, and the volume level is designated so that the volume of the voice sound source audio data is 56% by a user input or automatically, the processor 220 may adjust the volume level of the voice sound source audio data, among the first plurality of sound source audio data, to 56% and the volume level of the instrument sound source audio data to 100%. For example, when the first plurality of sound source audio data includes voice sound source audio data and noise sound source audio data, and it is designated that noise is removed by a user input or automatically, the processor 220 may adjust the volume level of the voice sound source audio data among the first plurality of sound source audio data to 100% and the volume level of the noise sound source audio data to 0%. The processor 220 according to an embodiment may display a content edit screen for designating (or changing) the volume level of each of the first plurality of sound source audio data and allow the volume level of at least some or all of the first plurality of sound source audio data to be designated (or changed) automatically or by a user input on the content edit screen.

In operation 650, the processor 220 according to an embodiment may mix the volume-adjusted first plurality of sound source audio data. The processor 220 according to an embodiment may mix the volume-adjusted first plurality of sound source audio data into a single piece of audio data through the audio processing module 370.

In operation 652, the processor 220 according to an embodiment may transmit the mixed first plurality of sound source audio data to the audio renderer 236. The processor 220 according to an embodiment may split the mixed first plurality of sound source audio data to fit the input data size of the audio renderer 236 and transmit the same to the audio renderer 236.

In operation 654, the processor 220 according to an embodiment may render the audio data through the audio renderer 236 and output the same through the audio output module 255.

In operation 656, the processor 220 according to an embodiment may identify whether the audio content is ended (e.g., end of stream (EOS)). The processor 220 according to an embodiment may terminate the playback and separation operation for the audio content if the end of the audio content is identified. If the end of the audio content is not identified, the processor 220 according to an embodiment may return to operation 616 to repeatedly perform decoding, separation, and audio rendering until the last audio data of the last time period of the audio content and then, if the end (e.g., end of stream (EOS)) of the audio content (e.g., audio stream) is identified, terminate the process.

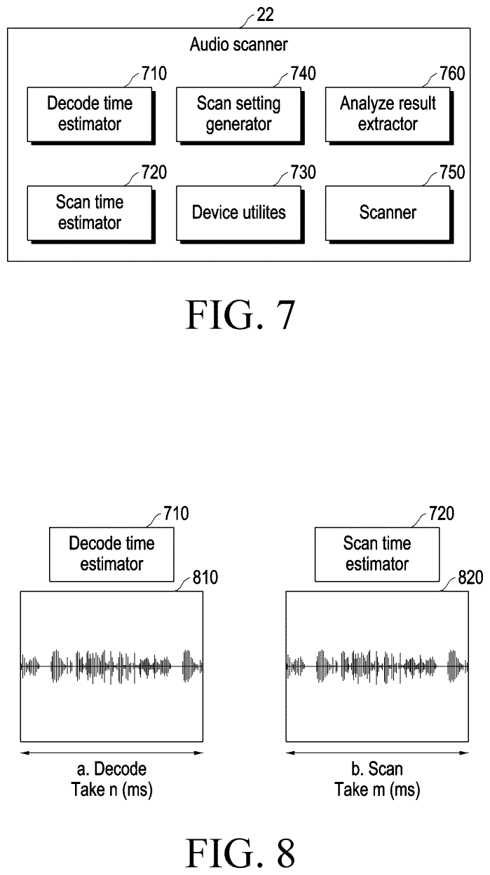

FIG. 7 is a block diagram illustrating an audio scanner according to an embodiment.

Referring to FIG. 7, the audio scanner 22 according to an embodiment may be stored in the memory 230 as a software module (or program). According to an embodiment, the audio scanner 22 may be implemented as a hardware module (or a component or element).

The processor 220 according to an embodiment may obtain, through the audio scanner 22, information about a section including a sound source (e.g., vocal, musical instrument, background sound, noise, and/or other sound sources) of a specific category among sections of the audio content (e.g., audio stream). The processor 220 according to an embodiment may obtain the section information about the audio category in the audio track by quickly analyzing a long audio track using the audio scanner 22.

The audio scanner 22 according to an embodiment may include a decode time estimator 710, a scan time estimator 720, device utilities 730, a scan setting generator 740, a scanner 750, and an analyze result extractor 760. The decode time estimator 710 according to an embodiment may estimate (or measure or obtain) the time needed to generate input data (e.g., PCM data) of the audio solution 234. The scan time estimator 720 according to an embodiment may estimate (or measure or obtain) the time needed to analyze audio data. The device utilities 730 according to an embodiment may obtain real time (current) status information about the electronic device 201 through the device utilities 730. The scan setting generator 740 according to an embodiment may obtain an estimated scan time for audio content and determine (or set) a scan interval and a skip interval to prevent the estimated scan time from exceeding a designated maximum scan time. The scanner 750 according to an embodiment may analyze PCM data to identify the audio category. The analyze result extractor 760 according to an embodiment may configure analysis result data of the audio solution 234.

The processor 220 according to an embodiment may obtain and store a seek time needed to decode the audio content and a decoding time taken to decode the audio data for each section in the decoder 232, through the decode time estimator 710 and obtain an average decoding time taken to decode the audio data of one section.

The processor 220 according to an embodiment may obtain an estimated scan time to be needed to scan the audio content using the product of the time needed to scan the audio data of one block and the number of blocks included in the time period of the audio content through the scan time estimator 720. For example, the scan time estimator 720 may determine the estimated scan time needed to scan the entire audio data. The estimated scan time may include the block scan time. The block may mean the size of the minimum scan input of the audio solution 234.

The processor 220 according to an embodiment may obtain real time (current) status information about the electronic device 201 through the device utilities 730. The processor 220 according to an embodiment may obtain, through the device utilities 730, the current hardware element information about the electronic device 201 (e.g., the usage amount and/or occupancy rate of the CPU, AP, and/or audio processor and/or memory 230 of the electronic device 201, power consumption of the battery (e.g., 189 of FIG. 1) of the electronic device 201), information about an application running in the background of the electronic device 201, and/or network connection status information about the electronic device 201. According to an embodiment, since the decoding time and/or the scan time may be varied depending on the real-time (current) status information about the electronic device 201, the device utilities 730 may obtain real-time (current) status information about the electronic device 201 every audio data section (or at designated time intervals) and transmit the same to the scan setting generator 740.

The processor 220 according to an embodiment may obtain, through the scan setting generator 740, an estimated scan time for the audio content using the time period corresponding to the audio content, status information about the electronic device, and the designated maximum scan time, and determine (or calculate or identify or update) the scan interval and the skip interval for preventing the estimated scan time from exceeding the designated maximum scan time. For example, the scan setting generator 740 may generate a scan interval and a skip interval for determining the section (e.g., a section to be analyzed next) to be analyzed among the audio data based on the information transmitted through the decode time estimator 710 and the scan time estimator 720, the status information about the electronic device 201 transmitted through the device utilities 730, and the maximum scan time set in the audio solution 234 (e.g., App). According to an embodiment, the scan setting generator 740 may designate the maximum scan wait time needed in the editor (e.g., an edit application) and the minimum scan interval of the audio solution 234 according to the editor and/or the audio solution 234, respectively, and calculate the estimated scan time using Equation 4 above.

The processor 220 according to an embodiment may sample the audio data of at least a partial section of the audio data of one section among the audio data using the scan interval and the skip interval through the scanner 750 and analyze the sampled audio data of the at least partial section to identify the sound source category to which the audio data of one section belongs.

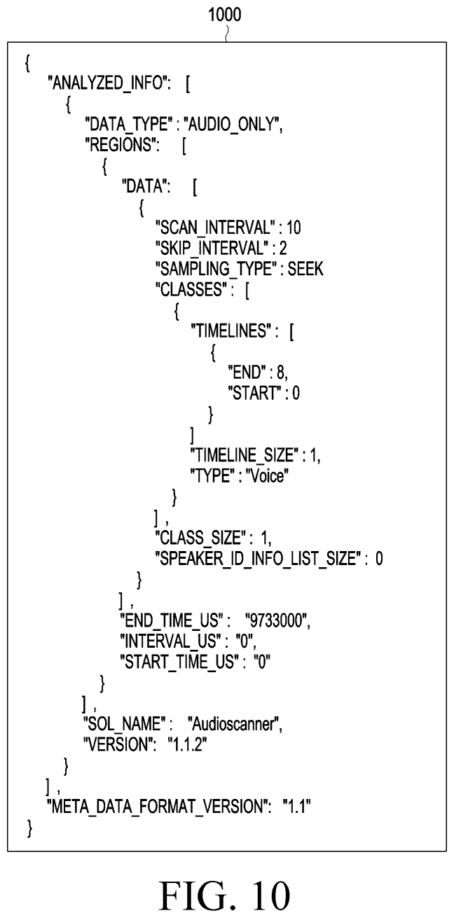

The processor 220 according to an embodiment may obtain the scan result information through the analyze result extractor 760 and store the scan result information in a designated data format. For example, the designated data format may be generated as a hierarchy format to be able to use the scan result information. The data format is described below in detail with reference to FIG. 10.

FIG. 8 is a view illustrating a decoding time and a scan time for audio data of a section according to an embodiment.

Referring to FIG. 8, the processor 220 according to an embodiment may obtain (or measure) the decoding time (decode take n(ms)) taken to decode the audio data 810 of one section for each audio data section in the decoder 232 through the decode time estimator 710. The processor 220 according to an embodiment may obtain (or measure) and store the scan time (scan take m(ms)) to scan (or analyze) the audio data 820 of one section for each audio data section through the scan time estimator 720. The stored decoding times and the scan times may be transmitted to the scan setting generator 740 and used.

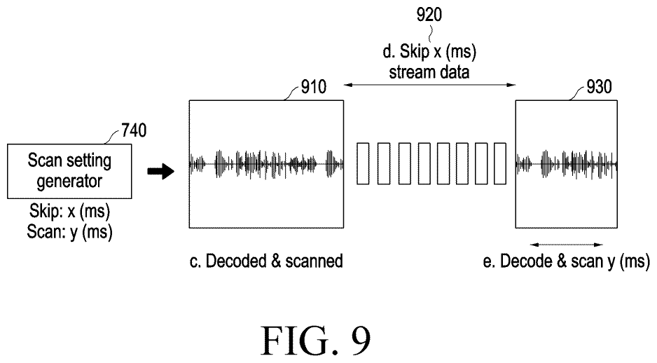

FIG. 9 is a view illustrating an example of setting an analysis period based on a skip interval and a scan interval according to an embodiment.

Referring to FIG. 9, the processor 220 according to an embodiment may calculate a skip interval (e.g., skip: x(ms)) and a scan interval (e.g., scan: y(ms)) based on the time taken (e.g., c. decoded & scanned) to analyze and scan the audio stream 910 of one previous section through the scan setting generator 740. The processor 220 according to an embodiment may skip the decoding and/or scanning process by the audio stream (e.g., d.skip x(ms) stream) 920 corresponding to the skip interval x(ms) based on the skip interval (e.g., skip: x(ms)) and the scan interval (e.g., scan: y(ms)), and analyze a new analysis section 930 corresponding to the scan interval (e. decoded & scanned y(ms)). When it takes a lot of time to analyze the previous analysis period 910, the processor 220 according to an embodiment may reduce the new analysis period 930 so that the scan time for the entire audio data does not exceed a designated maximum scan time. The processor 220 according to an embodiment may manage the time needed for analysis in real time according to the circumstance of the electronic device 201 based on the status information about the electronic device 201 and/or the processing time of each operation of the audio solution 234 when scanning through the audio scanner 22, thereby preventing the scan time from being delayed beyond a designated time even when the performance of the electronic device and/or the audio solution is different.

FIG. 10 is a view illustrating a designated data format for storing scan result information according to an embodiment.

Referring to FIG. 10, the processor 220 according to an embodiment may obtain the scan result information through the analyze result extractor 760, and store the scan result information in a designated data format 1000. The processor 220 according to an embodiment may obtain ANALZYED_INFO, META_DATA_FORMAT_VERSION, SCAN_INTERVAL, SKIP_INTERVA, SAMPLING_TYPE, CLASSES, TIMELINES, START_TIME_US, END_TIME_USTIME_LINE, and/or SOL_NAME, as the scan result information, through the analyze result extractor 760, and store the same in a designated data format 1000. For example, ANALZYED_INFO may mean the group of the whole analyzed information. META_DATA_FORMAT_VERSION may be version information for checking the metadata format history at the time of deriving the current scan result. SCAN_INTERVAL may be scan interval information. SKIP INTERVAL may be skip interval information. SAMPLING_TYPE may be information about the used sampling scheme (e.g., seek scheme or drop scheme). CLASSES and TIMELINES may be information representing the sound source name obtained through the scan analysis and the section in which the sound source is coming out. START_TIME_US and END_TIME_US may be information about the current content. Further, the data format 1000 may further include other information or may not include at least some of the above-described information.

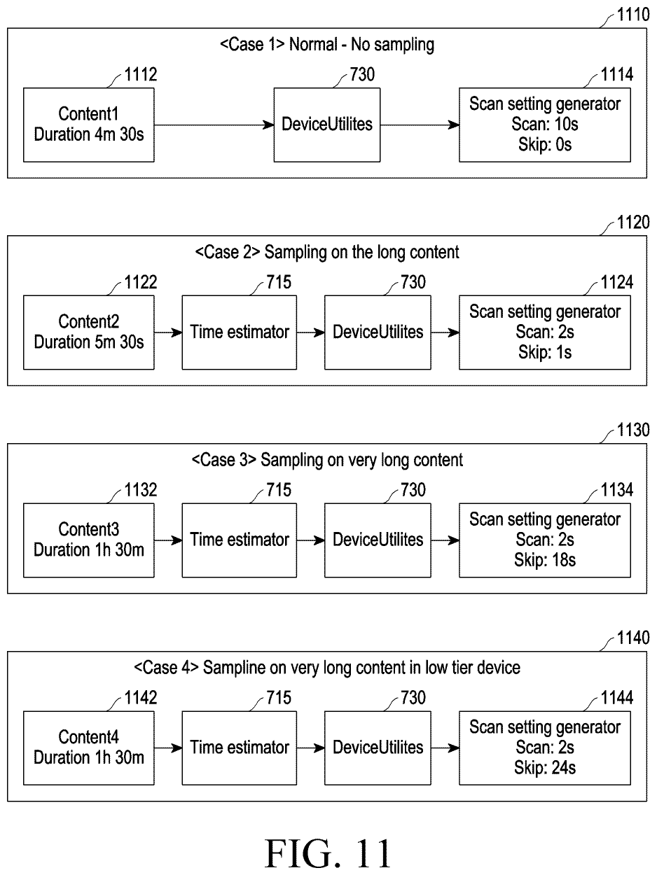

FIG. 11 is a view illustrating sampling processing cases when scanning content according to an embodiment.

Referring to FIG. 11, the first case (<case1> normal-normal sampling) 1110 according to an embodiment may be a case where content1 (content1, duration 4 m30 s) 1112 used in the current scan (e.g., sound source analysis) does not require sampling. According to an embodiment, the processor 220 may determine not to perform sampling through the scan setting generator 1114 when the length of content 1 1112 is short, and the status information about the electronic device 201 measured in the device utilities 730 is sufficient to process content 1 1112 as in the first case 1110. Accordingly, may set the skip interval to 0. In the first case 1110 according to an embodiment, the processor 220 may set the scan interval to a small value (e.g., 10 s) because sampling may need to be performed according to the status information about the electronic device 201 that changes in real time even if the length of content 1 1112 is short. In the first case 1110 according to an embodiment, even when the processor 220 sets the scan period in the scan setting generator 1114 to 10 s according to the length, 4 m 30 s, of content 1 1112, the processor 220 may adjust (or change) the scan period for additional sampling according to the status of the electronic device measured by the device utils.

The second case (<case2> sampling on the long content) 1120 according to an embodiment may be a case where the length of content2 (content2, duration 5 m30 s) 1122 is long and the total estimated time needed for scanning (e.g., sound source analysis) exceeds the maximum scan time according to the performance of the decoder 232 and the audio scanner 22 and the status information about the electronic device 201. The processor 220 according to an embodiment may determine a scan interval (e.g., scan: 2 s) and a skip interval (e.g., skip: 1 s) such that the scan time for content 2 1122 does not exceed the designated maximum scan time using the estimated decoding time and the estimated scan time obtained using the time estimator 715 (e.g., including the decode time estimator 710 and the scan time estimator 720), the time period corresponding to content 2 1122, the status information about the electronic device 201, and the designated maximum scan time and perform sound source analysis by sampling the audio data of at least a partial section among the audio data of content 2 1122 using the scan interval and the skip interval. The processor 220 may the scan period in scan setting generator 1124 according to the scan interval and skip interval.

The third case (<case3> sampling on very long content) 1130 according to an embodiment may be a case where the length of content 3 (content3, duration 1 h30 m) 1132 is longer than the length of content 2 1122. The processor 220 according to an embodiment may determine that the skip interval is a skip interval (e.g., skip: 18 s) larger than that of the second case through the scan setting generator 1134. The processor 220 according to an embodiment may variably determine (or set) a skip interval in the third case 1140 by comparing the skip interval setting in the second case 1120 with the skip interval setting in the third case 1130.

The fourth case (<case4> sampling on very long content in low tier device) 1140 according to an embodiment may be a case where the content is contet4 (content4, duration 1 h30 m) having the same length as that of the third case 1130, but the status information about the electronic device 201 has lower performance (e.g., the hardware element performance) than that of the third case 1130. The processor 220 according to an embodiment may determine that the skip interval is a skip interval (e.g., skip: 24 s) smaller than that of the third case through the scan setting generator 1144 when the status information about the electronic device 201 has lower performance (e.g., hardware element performance) than that of the third case 1130.

The processor 220 according to an embodiment may determine (or set) the skip interval of the fourth case to have more skip sections than the skip sections of the third case when the status information about the electronic device 201 has lower performance (e.g., performance of hardware element and/or software) than that of the third case 1130. For example, since the performance of the decoder 232 and/or the audio solution 234 may be deteriorated due to the performance (e.g., status) of the hardware element and/or software that changes (e.g., instantaneously) in real time in the electronic device 201, the processor 220 may set a skip interval different from that of the previous section to perform sound source analysis within a limited time.

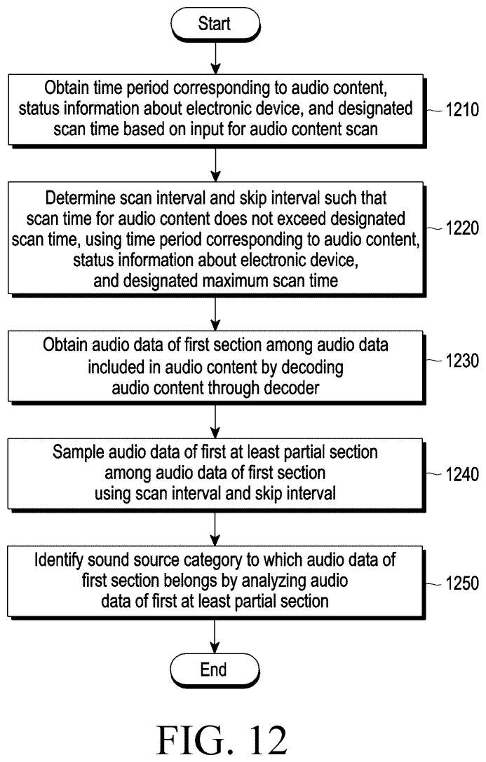

FIG. 12 is a flowchart illustrating an audio data scan operation according to an embodiment.

Referring to FIG. 12, the processor of the electronic device (e.g., the electronic device 101 of FIG. 1 or the electronic device 201 of FIG. 2) according to an embodiment (e.g., the processor 120 of FIG. 1 or the processor 220 of FIG. 2) may perform at least one of operations 1210 to 1250.

In operation 1210, the processor 220 according to an embodiment may obtain a time period (content duration) corresponding to the audio content, the status information about the electronic device 201, and a designated maximum scan time based on an input for scanning the audio content. For example, the status information about the electronic device 201 according to an embodiment may include the hardware element information (e.g., the usage amount and/or occupancy rate of at least one processor 220 (e.g., CPU, AP, and/or audio processor) and/or memory 230, power consumption of the battery (e.g., 189 of FIG. 1) of the electronic device 201), information about an application running in the background of the electronic device 201, and/or network connection status information about the electronic device 201. For example, the designated maximum scan time may be the scan limit time predefined for an application including the audio scanner 22 or the audio scanner 22 of the electronic device 201.

In operation 1220, the processor 220 according to an embodiment may obtain an estimated scan time for the audio content using the time period corresponding to the audio content, status information about the electronic device, and the designated maximum scan time, and determine (or calculate or identify) the scan interval and the skip interval for preventing the estimated scan time from exceeding the designated maximum scan time. The processor 220 according to an embodiment may obtain, as the estimated scan time, a large value among estimated scan times (e.g., a first estimated scan time) needed to scan audio content by using the value obtained by multiplying the estimated decoding time (e.g., a first estimated decoding time), which is estimated to be needed for decoding the audio content, by the time needed to scan audio data of a block and the number of blocks included in the time period of the audio content.

In operation 1230, the processor 220 according to an embodiment may obtain the audio data of the first section included in the audio data by decoding the audio data through the decoder 232 based on determining the scan interval and the skip interval.

In operation 1240, the processor 220 according to an embodiment may sample the audio data of first at least partial section of the audio data of the first section using the scan interval and the skip interval.

In operation 1250, the processor 220 according to an embodiment may analyze the sampled audio data of the first at least partial section to identify the sound source category to which the audio data of the first section belongs.

A method for scanning and separating audio data when playing content in an electronic device 101, 201, according to an embodiment of the disclosure, may comprise, based on an input for scanning audio content, determining a first scan interval by using a time period corresponding to the audio content so that a scan time for the audio content does not exceed a specified maximum scan time and the specified maximum scan time, and scan the audio content by sampling audio data corresponding to the audio content by using the first scan interval. The method may comprise, based on an input for playing the audio content, identifying audio data of first plurality of sound sources corresponding to first audio data of a first time period among the audio data corresponding to the audio content by using a result of the scanning while playing the audio data corresponding to the audio content, obtaining the audio data of the first plurality of the sound sources by performing separation of the first audio data of the first time period using a real time factor value, and outputting the audio data of the first plurality of sound sources through the audio output module.

According to an embodiment, the method may comprise identifying a first separation time to be needed to perform the separation of the first audio data of the first time period. The method may comprise, when a size of audio data of first plurality of sound sources obtained by performing the separation of the first audio data of the first time period is equal to or larger than a data size corresponding to a first audio rendering time associated with the first separation time, transmitting the audio data of the first plurality of sound sources to an audio renderer, and outputting the audio data of the first plurality of sound sources through the audio output module 155, 255. The method may comprise, when the size of the audio data of the first plurality of sound sources is smaller than the data size corresponding to the first audio rendering time associated with the first separation time, storing the audio data of the first plurality of sound sources in a first buffer of the memory 130, 230. The method may comprise obtaining audio data of second plurality of sound sources by performing separation on second audio data of a second time period following the first time period. The method may comprise, when the audio data of the first plurality of sound sources exists in the first buffer, merging the audio data of the first plurality of sound sources and the audio data of the second plurality of sound sources and transmitting the merged audio data to the audio renderer 236 to output through an audio output module 155, 255 of the electronic device.

According to an embodiment, the method may comprise obtaining the real time factor value by using a value obtained by dividing separation time taken when the electronic device 201 has performed separation before the first audio data of the first time period by the first time period. The method may comprise identifying the first separation time using the real time factor value.

According to an embodiment, the method may comprise identifying a cumulative average value of a plurality of real time factor values obtained when performing separation for each of a plurality of audio data before the first audio data of the first time period. The method may comprise identifying the first separation time by using the cumulative average value of the plurality of real time factor values and the status information of the electronic device.

In the method according to an embodiment, the status information of the electronic device may include at least one of usage amount of the at least one processor and/or the memory, an occupancy rate of the at least one processor and/or the memory, power consumption of a battery of the electronic device, information of an application which is running in a background of the electronic device, or information of network connection status of the electronic device.

According to an embodiment, the method may comprise, when the separation of the first audio data of the first time period is not performed, storing the first audio data of the first time period in a second buffer of the memory 130, 230. The method may comprise, when the first audio data exists in the second buffer when the audio data of the second plurality of sound sources is obtained by performing the separation of the second audio data of the second time period, merge the first audio data and the audio data of the second plurality of sound sources, transmitting the merged the first audio data and the audio data of the second plurality of sound sources to the audio renderer 236 to output the merged first audio data and the audio data of the second plurality of sound sources through the audio output module 155, 255.

According to an embodiment, the method may comprise obtaining the time period corresponding to the audio content, first status information of the electronic device 201, and the specified maximum scan time. The method may comprise determining the first scan interval and a first skip interval by using the time period corresponding to the audio content, the first status information of the electronic device 201, and the specified maximum scan time so that the scan time for the audio content does not exceed the specified maximum scan time. The method may comprise obtaining audio data of a first section among the audio data corresponding to the audio content by decoding the audio content through a decoder 232 of the electronic device. The method may comprise sampling at least part of the audio data of the first section by using the first scan interval and the first skip interval. The method may comprise identifying a sound source category of the audio data of the first section by analyzing the at least part of the audio data of the first section.

According to an embodiment, the method may comprise obtaining the time period corresponding to the audio content, first status information of the electronic device 201, and the specified maximum scan time based on the input for scanning the content. The method may comprise determining the first scan interval and a first skip interval by using the time period corresponding to the audio content, the first status information of the electronic device 201, and the specified maximum scan time so that the scan time for the audio content does not exceed the specified maximum scan time. The method may comprise obtaining audio data of a first section among the audio data corresponding to the audio content by decoding the audio content through a decoder 232 of the electronic device 201. The method may comprise sampling at least part of the audio data of the first section by using the first scan interval and the first skip interval. The method may comprise identifying a sound source category of the audio data of the first section by analyzing the at least part of the audio data of the first section.

According to an embodiment, the method may comprise obtaining second status information of the electronic device for scanning audio data of a second section following the audio data of the first section among the audio data. The method may comprise obtaining an expected decoding time needed for decoding the audio data of the second section. The method may comprise obtaining a scan time needed for scanning audio data of a specified time section. The method may comprise identifying a longer time among the expected decoding time and the scan time as an expected scan time for the audio data of the specified time section. The method may comprise determining a second scan interval and a second skip interval of the audio data of the second section based on the expected scan time, the second status information of the electronic device, and the specified maximum scan time. The method may comprise sampling at least part of the audio data of the second section by using the second scan interval and the second skip interval. The method may comprise identifying a sound source category of the audio data of the second section by analyzing the at least part of the audio data of the second section.

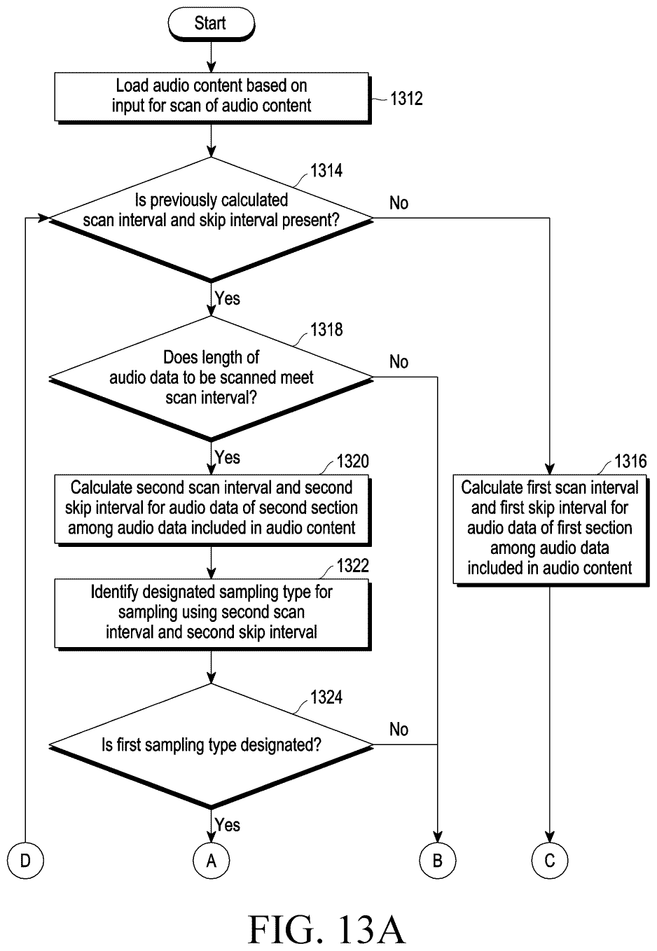

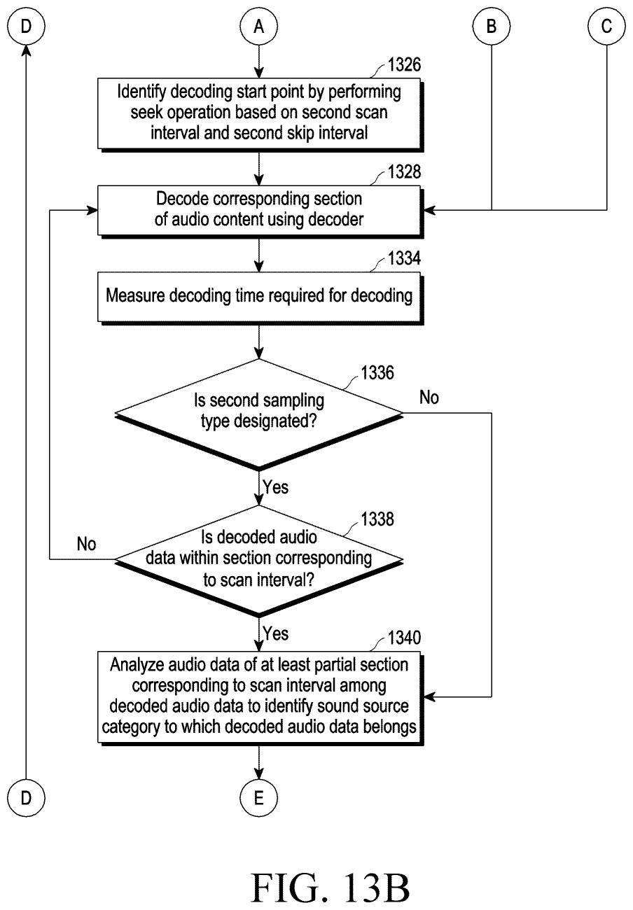

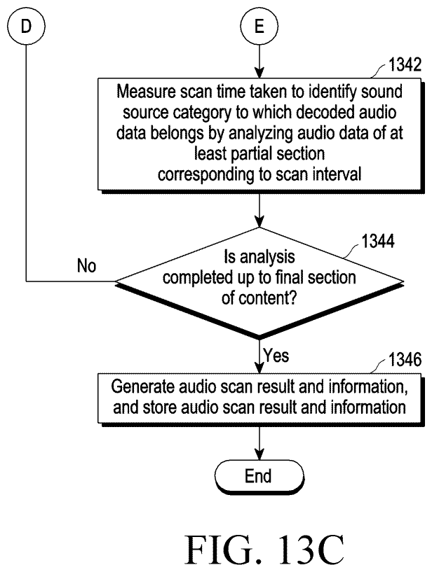

FIG. 13A is a flowchart illustrating an audio data scan operation according to the presence of a previously obtained scan interval and skip interval according to an embodiment. FIG. 13B is a flowchart illustrating operations continuing from 13A according to an embodiment. FIG. 13C is a flowchart illustrating operations continuing from 13B according to an embodiment.

Referring to FIGS. 13A to 13C, the processor of the electronic device (e.g., the electronic device 101 of FIG. 1 or the electronic device 201 of FIG. 2) according to an embodiment (e.g., the processor 120 of FIG. 1 or the processor 220 of FIG. 2) may perform at least one of operations 1312 to 1352.

In operation 1312, the processor 220 according to an embodiment may load the audio content based on an input for scanning the audio content. The processor 220 according to an embodiment may prepare for the audio to be scanned (or sound source analysis) based on an input for scanning the audio content.

In operation 1314, the processor 220 according to an embodiment may identify whether there is previously obtained (or calculated) scan interval and skip interval corresponding to the audio content. When an initial scan is performed on the audio content, previously obtained scan interval and skip interval information may not are present (e.g., not stored yet). For example, if a scan has been performed on the audio data of at least some sections of the loaded audio content, the previously obtained scan interval and skip interval may be present (e.g., stored).

In operation 1316, the processor 220 according to an embodiment may calculate a scan interval (e.g., a first scan interval) and a skip interval (e.g., a first scan interval) for audio data of a first section (e.g., an initial scan interval) among the audio data included in the audio content when the previously obtained scan interval and the skip interval are not present corresponding to the audio content. The processor 220 according to an embodiment may obtain a time period (content duration) corresponding to the audio content, status information (e.g., first status information) about the electronic device, and a designated maximum scan time when the previously obtained scan interval and skip interval are not present corresponding to the audio content to be scanned. For example, the first status information about the electronic device 101 according to an embodiment may include hardware element information (e.g., the usage amount and/or occupancy rate of at least one processor 220 (e.g., CPU, AP, and/or audio processor) and/or memory 230, power consumption of the battery (e.g., 189 of FIG. 1) of the electronic device 201), information about an application running in the background of the electronic device 201, and/or network connection status information about the electronic device 201, corresponding to a first time (e.g., the first section scan start time of the audio content). For example, the designated maximum scan time may be the scan limit time predefined for an application including the audio scanner 22 or the audio scanner 22 of the electronic device 201. The processor 220 according to an embodiment may obtain a first estimated scan time for the audio content using the time period corresponding to the audio content, first status information about the electronic device, and the designated maximum scan time, and determine (or calculate or identify) the first scan interval and the first skip interval for preventing the first estimated scan time from exceeding the designated maximum scan time. If the first scan interval and the first skip interval are determined, the processor 220 according to an embodiment may proceed to operation 1328.

In operation 1318, when the previously obtained scan interval (e.g., the first scan interval) and skip interval (e.g., the first skip interval) are present corresponding to the audio content, the processor 220 according to an embodiment may identify whether the length of the audio data to be scanned, obtained from the decoder 232, meets the scan interval (e.g., the first scan interval). When the length of the audio data to be scanned, obtained from the decoder 232, does not meet the scan interval (e.g., the first scan interval), the processor 220 according to an embodiment may proceed to operation 1328.

In operation 1320, when there is a previously obtained scan interval (e.g., the first scan interval) and a skip interval (e.g., the first scan interval) corresponding to the audio content, and the length of the audio data to be scanned, obtained from the decoder 232, meets the scan interval (e.g., the first scan interval), the processor 220 according to an embodiment may calculate (or update or determine) a scan interval (e.g., the second scan interval) and a skip interval (e.g., the second skip interval) for audio data of a second section (e.g., a section after the first section) among the audio data included in the audio content. The processor 220 according to an embodiment may obtain the first estimated decoding time, the first estimated scan time, the designated maximum scan time, the audio content time period (e.g., the time period of unscanned audio content among the audio content), and status information (e.g., second status information) about the electronic device to determine the second scan interval and the second skip interval. For example, the first status information about the electronic device 101 according to an embodiment may include hardware element information (e.g., the usage amount and/or occupancy rate of at least one processor 220 (e.g., CPU, AP, and/or audio processor) and/or memory 230, power consumption of the battery (e.g., 189 of FIG. 2) of the electronic device 201), information about an application running in the background of the electronic device 201, and/or network connection status information about the electronic device 201, corresponding to a second time (e.g., the second section scan start time of the audio content). The processor 220 according to an embodiment may determine (or calculate or identify) a second scan interval and a second skip interval for preventing the second estimated scan time for the audio data of the second section from exceeding the designated maximum scan time using the first estimated decoding time, the first estimated scan time, the designated maximum scan time, and the time period of unscanned audio content among the audio content, and status information (e.g., second status information) about the electronic device. The processor 220 according to an embodiment may identify a start time to which the second scan interval and the second skip interval are to be applied using the second skip interval.

In operation 1322, the processor 220 according to an embodiment may identify a sampling type designated for sampling using the second scan interval and the second skip interval. For example, the designated sampling type may include a first sampling type and/or a second sampling type. For example, the first sampling type may include a seek type (or a mode or operation). The second sampling type may include a drop method (or a mode or operation).

In operation 1324, the processor 220 according to an embodiment may identify whether a first sampling type (e.g., seek type) is designated. If the seek type is not designated, the processor 220 according to an embodiment may proceed to operation 1328.

In operation 1326, if the first sampling type (e.g., seek type) is designated, the processor 220 according to an embodiment may perform a seek operation based on the second scan interval to identify the decoding start point.

In operation 1328, the processor 220 according to an embodiment may decode the corresponding section (e.g., first section or second section) of the audio content using the decoder 232. The processor 220 according to an embodiment may decode the first section of the audio content (audio stream) in the next operation of operation 1316. The processor 220 according to an embodiment may decode the audio data of the second section of the audio content (audio stream) in the next operation of operation 1326 or operation 1318.

In operation 1334, the processor 220 according to an embodiment may measure (or measure and store) the decoding time (e.g., first decoding time or second decoding time) needed to decode the corresponding section (e.g., first section or second section) of the content.

In operation 1336, the processor 220 according to an embodiment may identify whether a second sampling type (e.g., drop type) is designated. If the drop type is not designated, the processor 220 according to an embodiment may proceed to operation 1340.

In operation 1338, if the drop type is designated, the processor 220 according to an embodiment may identify whether the decoded audio data is a section corresponding to the scan interval (first scan interval or second scan interval). If the decoded audio data is not a section corresponding to the scan interval (first scan interval or second scan interval), the processor 220 according to an embodiment may drop the audio data corresponding to the skip interval and return to operation 1328.

In operation 1340, if the decoded audio data corresponds to the scan interval (first scan interval or second scan interval), the processor 220 according to an embodiment may analyze the audio data of at least a partial section corresponding to the scan interval among the decoded audio data to identify the sound source category to which the decoded audio data belongs.

In operation 1342, the processor 220 according to an embodiment may analyze the audio data of at least a partial section corresponding to the scan interval to measure (or measure and store) the scan time taken to identify the sound source category to which the decoded audio data belongs.

In operation 1344, the processor 220 according to an embodiment may identify whether the scan (or sound source analysis) has been completed up to the decoded audio data of the last section of the audio content. The processor 220 according to an embodiment may repeatedly perform operations 1314 to 1342 if the scan (or sound source analysis) up to the decoded audio data of the last section of the audio content is not completed and then identify that the scan is completed if an end (e.g., end of stream (EOS)) of the audio content (e.g., audio stream) is identified.

In operation 1346, the processor 220 according to an embodiment may generate audio scan result information and store the audio scan result information in the memory 230. The processor 220 according to an embodiment may obtain the scan result information through the analyze result extractor 760 and store the scan result information in a designated data format (e.g., 1000).

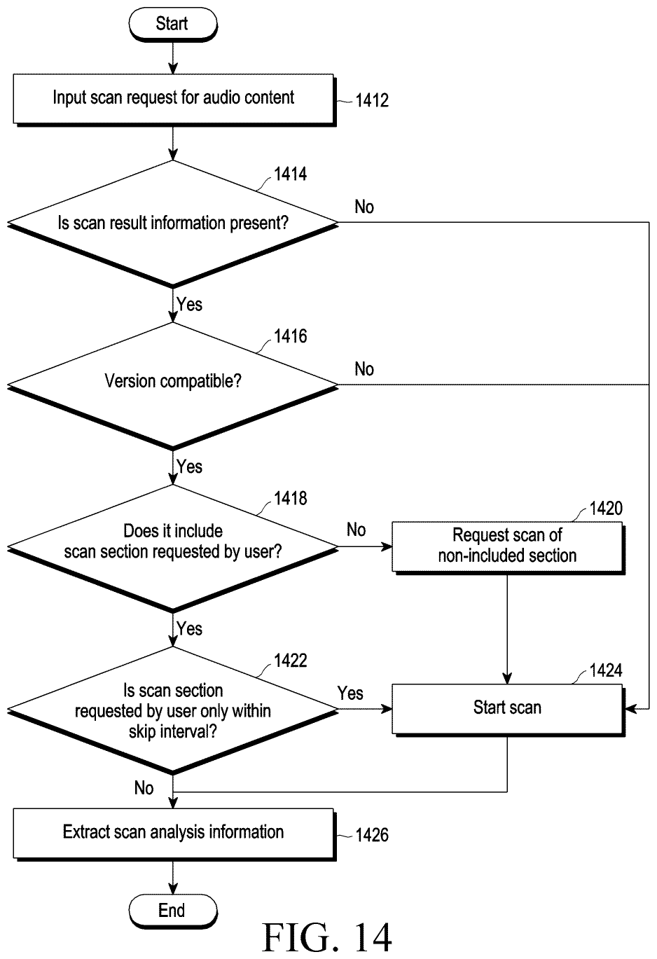

FIG. 14 is a flowchart illustrating a scan operation on audio content including scan result information according to an embodiment.

Referring to FIG. 14, according to an embodiment, a processor (e.g., the processor 120 of FIG. 1 or the processor 220 of FIG. 2) of an electronic device (e.g., the electronic device 101 of FIG. 1 or the electronic device 201 of FIG. 2) may perform at least one of operations 1412 to 1426.

In operation 1412, the processor 220 according to an embodiment may receive an input for requesting scan of the audio content.

In operation 1414, the processor 220 according to an embodiment may identify whether audio content scan result information is present in the memory 230 based on an input for requesting scan of the audio content. When the audio content scan result information is not present, the processor 220 according to an embodiment may proceed to operation 1424.

In operation 1416, when the audio content scan result information is present, the processor 220 according to an embodiment may identify whether the version of the stored audio content scan result information is a compatible version in the electronic device 201 (e.g., a version available in the electronic device 201). If the version of the stored audio content scan result information is not compatible in the electronic device 201, the processor 220 according to an embodiment may proceed to operation 1424.

In operation 1418, when the audio content scan result information is present and the version of the audio content scan result information is a version compatible in the electronic device 201 (e.g., a version available in the electronic device 201), the processor 220 according to an embodiment may identify whether the section requested to be scanned by the user is included in the audio content scan result information.

In operation 1420, the processor 220 according to an embodiment may request to scan the non-included section requested by the user and proceed to operation 1424 when the audio content scan result information is present and the version of the audio content scan result information is a version compatible in the electronic device 201 (e.g., a version available in the electronic device 201) and the sound source information of the section requested by the user is not included.

In operation 1422, the processor 220 according to an embodiment may identify whether the section requested by the user is included in the skip interval when the audio content scan result information is present and the version of the audio content scan result information is a version compatible in the electronic device 201 (e.g., a version available in the electronic device 201), and the section requested by the user is included. The processor 220 according to an embodiment may proceed to operation 1424 when the audio content scan result information is present, and the version of the audio content scan result information is a version compatible in the electronic device 201 (e.g., a version available in the electronic device 201), sound source information of the section requested by the user is included, and the section requested by the user is included in the skip interval.

In operation 1424, the processor 220 according to an embodiment may perform a scan operation for audio content.

In operation 1426, the processor 220 according to an embodiment may extract the sound source information of the section requested by the user. The processor 220 according to an embodiment may extract the sound source information of the section requested by the user as the result of the scan operation of operation 1424 or extract the sound source information of the section requested by the user from the audio content scan result information and display the same on the display 260.

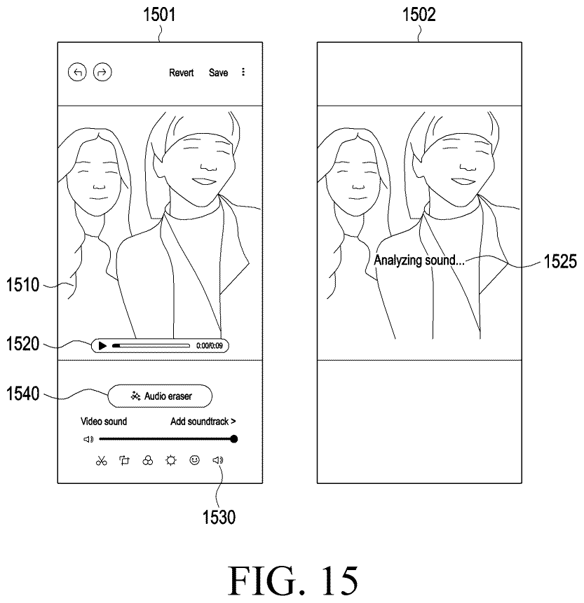

FIG. 15 is a view illustrating an example of a screen for audio scanning according to an embodiment.

Referring to FIG. 15, the processor 220 (e.g., the processor of FIG. 1) of the electronic device 201 (e.g., the electronic device 101 of FIG. 1) according to an embodiment may display a screen 1501 for an audio scan for content through the display 260. When the content includes video content and audio content, the processor 220 according to an embodiment may display an image 1510 corresponding to the video data included in the content on the screen 1501 for the scan of the content, display a bar 1520 indicating the section of the audio data, and display a menu 1530 associated with the audio scan. If the menu 1530 associated with the audio scan is selected, the processor 220 according to an embodiment may display a scan request icon 1540 for obtaining information about a section including a sound source (e.g., vocal, musical instrument, background sound, noise, and/or other sound sources) of a specific category among sections of the audio content (e.g., audio stream) of the content (e.g., video or audio file). The processor 220 according to an embodiment may display the scan request icon 1540 for obtaining the information about the section including specific sound source data (e.g., noise sound source data, auto eraser or noise reduction). The processor 220 according to an embodiment may display a screen 1502 indicating that audio scan is in progress through the display 260 based on a user input to the scan request icon 1540 and display information 1525 indicating that audio analysis is in progress on the screen 1502 indicating that audio scan is in progress while performing a scan within a limited maximum scan time through the scan operation of the disclosure. The processor 220 according to an embodiment may store the scan result information in the memory 230.

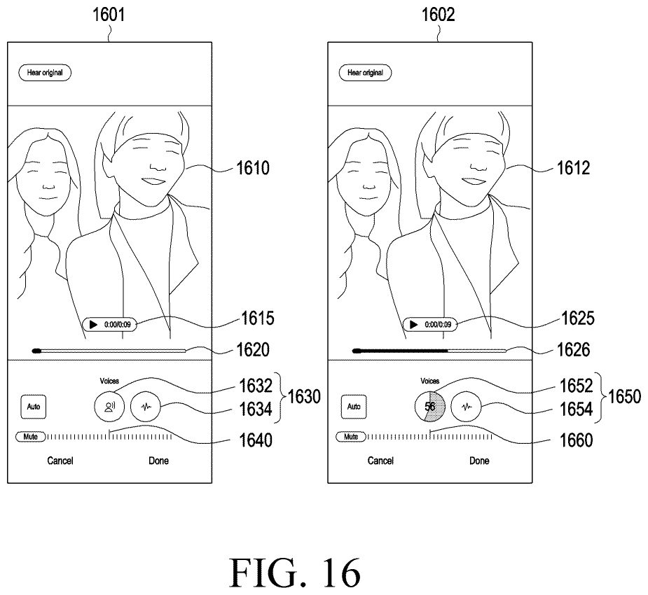

FIG. 16 is a view illustrating an example of a screen displaying an audio scan result according to an embodiment.

Referring to FIG. 16, the processor 220 (e.g., the processor of FIG. 1) of the electronic device 201 (e.g., the electronic device 101 of FIG. 1) according to an embodiment may update and display screens (e.g., 1601 and 1602) displaying the audio scan result of content through the display 260 over time while performing a scan for content. The processor 220 according to an embodiment may display an image 1610 corresponding to video data included in the content on the screen 1601 displaying the audio scan result of the content of a first section 1615 of the audio data, display a bar 1620 indicating the first section 1615 of the audio data, and display at least one sound source information icon 1630 (e.g., an icon 1632 indicating vocal sound source audio data and/or an icon 1634 indicating noise sound source audio data) corresponding to a first point 1640 of the first section of the audio content using the audio scan result information. A processor 220 according to an embodiment may display an image 1612 corresponding to video data included in content on a screen 1602 displaying an audio scan result of content of a second section 1625 of audio data, and may display a bar 1626 representing the second section 1625 of audio data, and may display at least one sound source information icon 1650 (e.g., an icon 1651 representing vocal sound source audio data and/or an icon 1652 representing noise sound source audio data) corresponding to a first point 1660 of the second section 1625 of audio content using audio scan result information. In the screen 1602 displaying the audio scan result of the content of the second section 1625 of the audio data, the processor 220 may receive an input for adjusting the volume using each icon 1652 or 1654 from the user and set (or store) the volume adjustment value for each piece of sound source audio data according to the user input. For example, when receiving an input for adjusting the volume of the vocal sound source audio data to 56% from the user using the icon 1652 indicating the vocal sound source audio data, the processor 220 may set the volume adjustment value for the vocal sound source audio data included in the audio content to 56%. The processor 220 according to an embodiment may apply the stored or set volume adjustment value to the separated sound source audio data when playing content.

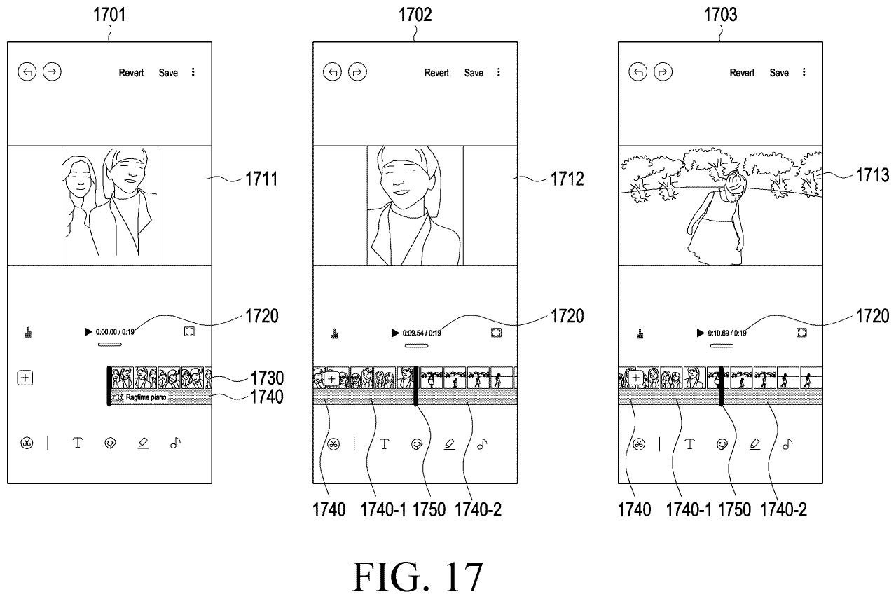

FIG. 17 is a view illustrating an example of a screen for content editing according to an embodiment.

Referring to FIG. 17, the processor 220 (e.g., the processor of FIG. 1) of the electronic device 201 (e.g., the electronic device 101 of FIG. 1) according to an embodiment may display a screen 1701 for editing (and/or playing) content through the display 260. Content according to an embodiment may include audio content and video content. The audio content according to an embodiment may include first audio content and second audio content. The first audio content and the second audio content according to an embodiment may be continuous and different audio content. The processor 220 according to an embodiment may display a first screen 1701 for editing (and/or playing) content on the display 260 based on the execution of a content playback application (or content editing application) (or program). The processor 220 according to an embodiment may display a first image 1711 of video content included in the content on the first screen 1701 for editing (and/or playing) the content and display an object 1720 for starting and stopping the playback. The processor 220 according to an embodiment may display the images 1730 of the video content played according to the timeline and the audio content 1740 played according to the timeline on the first screen 1701 for editing (and/or playing) the content. The processor 220 according to an embodiment may play the video content and the audio content according to the timeline and, when it is needed to separate the audio data for each section of the audio content while playing the audio content, perform separation on the section requiring separation of the audio data and/or adjust the volume of the separated sound source audio data. When receiving an input for starting the playback through an object 1720 for starting and stopping the playback on the first screen 1701 for editing (and/or playing) the content, the processor 220 according to an embodiment may perform scheduling using a real time factor value and update and display (e.g., 1702 and 1703) the screen 1701 for editing (and/or playing) content according to the playback of the audio content together with the video content. Referring to the first screen 1701 for editing (and/or playing) the content according to an embodiment, since there is no data prepared for audio rendering when a plurality of sound source audio data (pcm output) are obtained after the first separation of the audio data of the first section of the audio content, the processor 220 may delay audio rendering by storing the first pcm output in the first buffer. The processor 220 may perform audio rendering on the next pcm outputs without delay because data prepared for audio rendering may be sufficient from the audio data separation operation on the next section of the first section. Referring to the second screen 1702 for editing (and/or playing) the content according to an embodiment, when the audio content includes first audio content 1740-1 and second audio content 1740-2, the processor 220 may display the first audio content 1740-1 and the second audio content 1740-2 on the timeline as in the second screen 1702 for editing (and/or playing) the content and may display the current playback position 1750.

When the audio content includes the first audio content 1740-1 and the second audio content 1740-2, the first audio content 1740-1 and the second audio content 1740-2 are different audio contents and are the last audio data of the first audio content 1740-1, the processor 220 according to an embodiment may display the second image 1712 of the video content while performing separation on the last audio data as in the second screen 1702 for editing (and/or playing) the content. When the size of the plurality of sound source audio data after separation of the last audio data of the first audio content 1740-1 is smaller than the size of the data prepared for audio rendering, the processor 220 according to an embodiment may separate the last audio data of the first audio content 1740-1 and then store the first plurality of sound source audio data in the first buffer to delay audio rendering.

The processor 220 according to an embodiment may allow a first plurality of sound source audio data and a second plurality of sound source audio data to be merged and processed when obtaining the second plurality of sound source audio data by performing separation on the first audio data of the next second audio content 1740-2 of the last audio data of the first audio content 1740-1 while displaying a third image 1713 of video content as in the third screen 1703 for editing (and/or playing) content, thereby preventing an audio drop.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. The electronic devices according to an embodiment are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1 st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to an embodiment, in a non-transitory storage medium storing instructions configured to, when executed by an electronic device, enable the electronic device to perform at least one operation, the at least one operation may comprise based on an input for scanning audio content, determining a first scan interval by using a time period corresponding to the audio content so that a scan time for the audio content does not exceed a specified maximum scan time and the specified maximum scan time, and scan the audio content by sampling audio data corresponding to the audio content by using the first scan interval. The at least one operation may comprise, based on an input for playing the audio content, identifying audio data of first plurality of sound sources corresponding to first audio data of a first time period among the audio data corresponding to the audio content by using a result of the scanning while playing the audio data corresponding to the audio content, obtaining the audio data of the first plurality of the sound sources by performing separation of the first audio data of the first time period using a real time factor value, and outputting the audio data of the first plurality of sound sources through the audio output module.

The embodiments shown and described in the specification and the drawings are provided merely for better understanding of the disclosure, and the disclosure should not be limited thereto or thereby. It should be appreciated by one of ordinary skill in the art that various changes in form or detail may be made to the embodiments without departing from the scope of the disclosure defined by the following claims.

What is claimed is:

1. An electronic device comprising:
a display;
an audio output module comprising a speaker;
memory storing instructions; and
at least one processor,
wherein the instructions, when executed by the at least one processor individually or collectively, cause the electronic device to:
based on an input for scanning audio content:
determine a specified maximum scan time and a first scan interval by using a time period corresponding to the audio content so that a scan time for the audio content does not exceed the specified maximum scan time, and
scan the audio content by sampling audio data corresponding to the audio content by using the first scan interval, and
based on an input for playing the audio content:
identify audio data of a first plurality of sound sources corresponding to first audio data of a first time period among the audio data corresponding to the audio content, wherein the audio data of the first plurality of sound sources is identified by using a result of the scanning of the audio content while playing the audio data corresponding to the audio content,
obtain the audio data of the first plurality of sound sources by performing separation of the first audio data of the first time period using a real time factor value, and
output the audio data of the first plurality of sound sources through the audio output module.

2. The electronic device of claim 1,
wherein the instructions, when executed by the at least one processor individually or collectively, cause the electronic device to:
identify a first separation time for performing the separation of the first audio data of the first time period, and
when a size of the audio data of the first plurality of sound sources obtained by performing the separation of the first audio data of the first time period is equal to or larger than a data size corresponding to a first audio rendering time associated with the first separation time:
transmit the audio data of the first plurality of sound sources to an audio renderer, and
output the audio data of the first plurality of sound sources through the audio output module, or
when the size of the audio data of the first plurality of sound sources is smaller than the data size corresponding to the first audio rendering time associated with the first separation time, store the audio data of the first plurality of sound sources in a first buffer of the memory,
wherein the instructions, when executed by the at least one processor individually or collectively, cause the electronic device to:
obtain audio data of a second plurality of sound sources by performing separation on second audio data of a second time period, the second time period following the first time period, and
when the audio data of the first plurality of sound sources is stored in the first buffer:
merge the audio data of the first plurality of sound sources and the audio data of the second plurality of sound sources, and
transmit the merged audio data to the audio renderer to output through the audio output module.

3. The electronic device of claim 1,
wherein the instructions, when executed by the at least one processor individually or collectively, cause the electronic device to:
obtain the real time factor value by using a value obtained by dividing separation time by the first time period, wherein the separation time is taken when the electronic device has performed separation before the first audio data of the first time period.

4. The electronic device of claim 2,
wherein the instructions, when executed by the at least one processor individually or collectively, cause the electronic device to:
identify a cumulative average value of a plurality of real time factor values obtained when performing separation for each of a plurality of audio data before the first audio data of the first time period, and
identify the first separation time by using the cumulative average value of the plurality of real time factor values and status information of the electronic device.

5. The electronic device of claim 4,
wherein the status information of the electronic device comprises at least one of an usage amount of the at least one processor and/or the memory, an occupancy rate of the at least one processor and/or the memory, power consumption of a battery of the electronic device, information of an application which is running in a background of the electronic device, or information of network connection status of the electronic device.

6. The electronic device of claim 2,
wherein the instructions, when executed by the at least one processor individually or collectively, cause the electronic device to:
when the separation of the first audio data of the first time period is not performed, store the first audio data of the first time period in a second buffer of the memory, and
when the first audio data is stored in the second buffer when the audio data of the second plurality of sound sources is obtained by performing the separation of the second audio data of the second time period:
merge the first audio data and the audio data of the second plurality of sound sources,
transmit the merged first audio data and audio data of the second plurality of sound sources to the audio renderer to output the merged first audio data and audio data of the second plurality of sound sources through the audio output module.

7. The electronic device of claim 2,
wherein the audio content comprises first audio content comprising the first audio data of the first time period and second content comprising the second audio data of the second time period,
wherein the instructions, when executed by the at least one processor individually or collectively, cause the electronic device to:
identify whether the first audio data of the first time period and the second audio data of the second time period are continuous, and
when the first audio data of the first time period and the second audio data of the second time period are continuous, update first inference data by accumulating separation result information for the second content to follow separation result information for the first audio content without initializing the first inference data that has accumulated separation result information for the first audio content, or
when the first audio data of the first time period and the second audio data of the second time period are not continuous:
initialize the first inference data, and
obtain second inference data that has accumulated separation result information for the second content.

8. The electronic device of claim 1,
wherein the instructions, when executed by the at least one processor individually or collectively, cause the electronic device to:
based on the input for scanning the audio content, obtain the time period corresponding to the audio content, first status information of the electronic device, and the specified maximum scan time,
determine the first scan interval and a first skip interval by using the time period corresponding to the audio content, the first status information of the electronic device, and the specified maximum scan time so that the scan time for the audio content does not exceed the specified maximum scan time,
obtain audio data of a first section among the audio data corresponding to the audio content by decoding the audio content through a decoder,
sample at least part of the audio data of the first section by using the first scan interval and the first skip interval, and
identify a sound source category of the audio data of the first section by analyzing the at least part of the audio data of the first section.

9. The electronic device of claim 8,
wherein the instructions, when executed by the at least one processor individually or collectively, cause the electronic device to:
obtain second status information of the electronic device for scanning audio data of a second section following the audio data of the first section among the audio data corresponding to the audio content,
obtain an expected decoding time needed for decoding the audio data of the second section,
obtain a scan time needed for scanning audio data of a specified time section, identify a longer time among the expected decoding time and the scan time as an expected scan time for the audio data of the specified time section,
determine a second scan interval and a second skip interval of the audio data of the second section based on the expected scan time, the second status information of the electronic device, and the specified maximum scan time,
sample at least part of the audio data of the second section by using the second scan interval and the second skip interval, and
identify a sound source category of the audio data of the second section by analyzing the at least part of the audio data of the second section.

10. The electronic device of claim 9,
wherein the instructions, when executed by the at least one processor individually or collectively, cause the electronic device to:
when a first sampling type is specified for sampling using the second scan interval and the second skip interval, calculate a starting point of the second section based on the second scan interval,
obtain the audio data of the second section among the audio data corresponding to the audio content by decoding from the starting point of the second section by using the decoder, and
sample at least part of the audio data of the second section by using the second scan interval and the second skip interval.

11. The electronic device of claim 9,
wherein the instructions, when executed by the at least one processor individually or collectively, cause the electronic device to:
when a second sampling type is specified for sampling using the second scan interval and the second skip interval, obtain the audio data of the second section among the audio data corresponding to the audio content by using the decoder, and
sample at least part of the audio data of the second section corresponding to the second scan interval.

12. A method for scanning and separating audio data in an electronic device, the method comprising:
based on an input for scanning audio content:
determining a specified maximum scan time and a first scan interval by using a time period corresponding to the audio content so that a scan time for the audio content does not exceed the specified maximum scan time, and
scan the audio content by sampling audio data corresponding to the audio content by using the first scan interval; and
based on an input for playing the audio content:
identifying audio data of a first plurality of sound sources corresponding to first audio data of a first time period among the audio data corresponding to the audio content, wherein the audio data of the first plurality of sound sources is identified by using a result of the scanning of the audio content while playing the audio data corresponding to the audio content,
obtaining the audio data of the first plurality of sound sources by performing separation of the first audio data of the first time period using a real time factor value, and
outputting the audio data of the first plurality of sound sources through an audio output module comprising a speaker.

13. The method of claim 12, further comprising:
identifying a first separation time for performing the separation of the first audio data of the first time period, and
when a size of audio data of the first plurality of sound sources obtained by performing the separation of the first audio data of the first time period is equal to or larger than a data size corresponding to a first audio rendering time associated with the first separation time:
transmitting the audio data of the first plurality of sound sources to an audio renderer, and
outputting the audio data of the first plurality of sound sources through the audio output module; or
when the size of the audio data of the first plurality of sound sources is smaller than the data size corresponding to the first audio rendering time associated with the first separation time, storing the audio data of the first plurality of sound sources in a first buffer of memory of the electronic device,
wherein the method further comprises:
obtaining audio data of a second plurality of sound sources by performing separation on second audio data of a second time period, the second time period following the first time period; and
when the audio data of the first plurality of sound sources is stored in the first buffer:
merging the audio data of the first plurality of sound sources and the audio data of the second plurality of sound sources, and
transmitting the merged audio data to the audio renderer to output through the audio output module of the electronic device.

14. The method of claim 12, further comprising obtaining the real time factor value by using a value obtained by dividing separation time by the first time period, wherein the separation time is taken when the electronic device has performed separation before the first audio data of the first time period.

15. The method of claim 13, further comprising:
identifying a cumulative average value of a plurality of real time factor values obtained when performing separation for each of a plurality of audio data before the first audio data of the first time period; and
identifying the first separation time by using the cumulative average value of the plurality of real time factor values and status information of the electronic device.

16. The method of claim 15,
wherein the status information of the electronic device comprises at least one of an usage amount of at least one processor and/or memory of the electronic device, an occupancy rate of the at least one processor and/or the memory, power consumption of a battery of the electronic device, information of an application which is running in a background of the electronic device, or information of network connection status of the electronic device.

17. The method of claim 13, further comprising:
when the separation of the first audio data of the first time period is not performed, storing the first audio data of the first time period in a second buffer of memory of the electronic device; and
when the first audio data is stored in the second buffer when the audio data of the second plurality of sound sources is obtained by performing the separation of the second audio data of the second time period:
merging the first audio data and the audio data of the second plurality of sound sources, and
transmitting the merged first audio data and audio data of the second plurality of sound sources to the audio renderer to output the merged first audio data and audio data of the second plurality of sound sources through the audio output module.

18. The method of claim 12, further comprising:
based on the input for scanning the audio content, obtaining the time period corresponding to the audio content, first status information of the electronic device, and the specified maximum scan time;
determining the first scan interval and a first skip interval by using the time period corresponding to the audio content, the first status information of the electronic device, and the specified maximum scan time so that the scan time for the audio content does not exceed the specified maximum scan time;
obtaining audio data of a first section among the audio data corresponding to the audio content by decoding the audio content through a decoder of the electronic device;
sampling at least part of the audio data of the first section by using the first scan interval and the first skip interval; and
identifying a sound source category of the audio data of the first section by analyzing the at least part of the audio data of the first section.

19. The method of claim 18, further comprising:
obtaining second status information of the electronic device for scanning audio data of a second section following the audio data of the first section among the audio data corresponding to the audio content;
obtaining an expected decoding time needed for decoding the audio data of the second section;
obtaining a scan time needed for scanning audio data of a specified time section;
identifying a longer time among the expected decoding time and the scan time as an expected scan time for the audio data of the specified time section;
determining a second scan interval and a second skip interval of the audio data of the second section based on the expected scan time, the second status information of the electronic device, and the specified maximum scan time;
sampling at least part of the audio data of the second section by using the second scan interval and the second skip interval; and
identifying a sound source category of the audio data of the second section by analyzing the at least part of the audio data of the second section.

20. A non-transitory storage medium storing instructions, wherein the instructions are configured to, when executed by an electronic device, enable the electronic device to perform at least one operation, the at least one operation comprising:
based on an input for scanning audio content:
determining a specified maximum scan time and a first scan interval by using a time period corresponding to the audio content so that a scan time for the audio content does not exceed the specified maximum scan time, and
scan the audio content by sampling audio data corresponding to the audio content by using the first scan interval; and
based on an input for playing the audio content:
identifying audio data of first plurality of sound sources corresponding to first audio data of a first time period among the audio data corresponding to the audio content, wherein the audio data of the first plurality of sound sources is identified by using a result of the scanning of the audio content while playing the audio data corresponding to the audio content,
obtaining the audio data of the first plurality of sound sources by performing separation of the first audio data of the first time period using a real time factor value, and
outputting the audio data of the first plurality of sound sources through an audio output module comprising a speaker.
